(19) United States
(12) Patent Application Publication
(10) Pub. No.: US 2026/0209085 A1
(43) Pub. Date: Jul. 23, 2026

(54) HYDRODYNAMIC SEPARATOR WITH ALTERNATING BAFFLES

(71) Applicant: Advanced Drainage Systems, Inc., Hilliard, OH (US)

(72) Inventors: Bo LIU, Clarksburg, MD (US); Erik HARTWELL, Mount Airy, MD (US); Robin MALISZEWSKYJ, Middletown, MD (US); Gordon BAUGH, Columbus, OH (US); Jordan TENANDAR, Columbus, OH (US)

(73) Assignee: Advanced Drainage Systems, Inc., Hilliard, OH (US)

(21) Appl. No.: 19/397,620

(22) Filed: Nov. 21, 2025

Related U.S. Application Data
(60) Provisional application No. 63/748,105, filed on Jan. 22, 2025.

(51) Int. Cl. C02F 1/38; C02F 103/00

(52) U.S. Cl. CPC C02F 1/38; C02F 2103/001; C02F 2201/002

(57) ABSTRACT

The disclosed embodiments include a separator configured to remove particulate matter and pollutants from a flow of water. The separator may comprise a tubular body comprising an inlet chamber and a sump chamber separated by an upper cone. The inlet chamber may comprise a vertical riser comprising an inlet port configured to direct the flow of water from the inlet chamber to the sump chamber. The sump chamber may comprise a plurality of upward baffles, wherein each of the plurality of upward baffles extend outwardly from a vertical cylinder section, a plurality of downward baffles, wherein each of the plurality of downward baffles extend outwardly from the vertical cylinder section. The plurality of upward baffles and the plurality of downward baffles may be connected vertically in an alternating pattern to form a vertical cylinder configured to connect to the vertical riser.

### CROSS-REFERENCE TO RELATED APPLICATIONS

This application claims the benefit of priority of U.S. Provisional Application No. 63/748,105, filed Jan. 22, 2025, the contents of which are incorporated herein by reference in their entirety.

### TECHNICAL FIELD

This disclosure relates generally to systems, methods, and apparatuses for removing sediment and suspended solids from a flow of stormwater, and more particularly, to removing sediment and suspended solids from a flow of stormwater through use of a hydrodynamic separator.

### BACKGROUND

Stormwater management systems may be used to divert a flow of stormwater, such as runoff from rainfall events, from impervious surfaces and buildings. Stormwater management systems may, for example, include stormwater chambers or crates in which sediment, debris, pollutants, or particulates may be removed from stormwater. As such, stormwater chambers or crates may be provided underground to capture stormwater and to separate and retain particulates until they are deposited in the ground or in an off-site location.

Stormwater management systems may also use hydrodynamic separators to remove suspended solids, sediment, and other contaminants from stormwater. A hydrodynamic separator may be installed as part of a stormwater management system to remove particulates from the flow of stormwater before the stormwater enters a stormwater management chamber or crate. Improvements to hydrodynamic separators are needed to increase the amount of particulate matter that may be separated from the flow of stormwater. Such improved hydrodynamic separators may neutralize velocities of the flow of stormwater to allow more particulate matter to separate from the flow of the stormwater within a sump chamber of the hydrodynamic separator. Such improved hydrodynamic separators may also mitigate the risk of resuspended sediment short circuiting to the outlet of the separator under high flow conditions.

### SUMMARY

The disclosed embodiments describe systems, methods, and devices for a separator configured to remove particulate matter and pollutants from a flow of stormwater. The separator may comprise a tubular body, the tubular body comprising an inlet chamber and a sump chamber separated by an upper cone, a vertical cylinder extending from the inlet chamber to the sump chamber, a plurality of upward baffles in the sump chamber, wherein the plurality of upward baffles may extend towards an inner wall of the tubular body, a plurality of downward baffles in the sump chamber, wherein the plurality of downward baffles may extend to and/or be attached to the vertical cylinder, and wherein the plurality of upward baffles and the plurality of downward baffles may alternate along a length of the vertical cylinder.

In some embodiments, the tubular body may further comprise an inlet and an outlet. In some embodiments, the inlet chamber may be configured to contain the flow of stormwater entering the tubular body from the inlet. In some embodiments, a diameter of the upper cone may correspond to a diameter of the tubular body. In some embodiments, the upper cone may further comprise a bypass weir configured to prevent the flow of stormwater in the inlet chamber from exiting the inlet chamber through the outlet. In some embodiments, the vertical cylinder may comprise a plurality of connected vertical cylinder sections, wherein each of the plurality of vertical cylinder sections taper from a larger first end inwardly towards a smaller second end. In some embodiments, a vertical cylinder section may comprise an inlet port configured to allow the flow of stormwater to enter the sump chamber from the inlet chamber. In some embodiments, the sump chamber may be configured to allow sediments to settle from the flow of stormwater at a base of the sump chamber.

In some embodiments, each of the plurality of upward baffles may comprise, a first end, comprising a first diameter, a second end, comprising a second diameter, and wherein the first diameter may be larger than the second diameter. In some embodiments, the second end of the plurality of upward baffles may be located below the first end. In some embodiments, the separator may further comprise a gap between the second end of each of the plurality of upward baffles and the vertical cylinder. In some embodiments, each of the plurality of downward baffles may comprise a first end, comprising a first diameter, a second end, comprising a second diameter, and wherein the first diameter may be larger than the second diameter. In some embodiments, the second end of the plurality of downward baffles may be located above the first end. In some embodiments, the separator may further comprise a gap between the first end of each of the plurality of downward baffles and an inner wall of the tubular body. In some embodiments, the plurality of upward baffles and the plurality of downward baffles may extend at an angle between 0 degrees to 65 degrees. In some embodiments, a space between an adjacent one of the plurality of upward baffles and one of the plurality of downward baffles may comprise a distance between about 2 inches to about 13 inches. In some embodiments, the plurality of upward baffles may comprise three upward baffles. In some embodiments, the plurality of downward baffles may comprise three downward baffles. In some embodiments, the flow of stormwater may be configured to flow between the plurality of upward baffles and the plurality of downward baffles to an outlet. In some embodiments, the plurality of upward baffles and the plurality of downward baffles may be configured to reduce a velocity of the flow of stormwater.

The disclosed embodiments further include a separator configured to remove particulate matter and pollutants from a flow of water. The separator may comprise a tubular body, the tubular body comprising an inlet chamber and a sump chamber separated by an upper cone. The inlet chamber may comprise a vertical riser comprising an inlet port configured to direct the flow of water from the inlet chamber to the sump chamber. The sump chamber may comprise a plurality of upward baffles, wherein each of the plurality of upward baffles extend outwardly from a vertical cylinder section, a plurality of downward baffles, wherein each of the plurality of downward baffles extend outwardly from the vertical cylinder section, and wherein the plurality of upward baffles and the plurality of downward baffles are connected vertically in an alternating pattern to form a vertical cylinder configured to connect to the vertical riser.

In some embodiments, the tubular body may further comprise an inlet configured to receive the flow of water from a source. In some embodiments, the tubular body may further comprise an outlet configured to remove the flow of water from the separator. In some embodiments, the inlet chamber may further comprise a bypass weir configured to prevent the flow of water from entering the outlet from the inlet chamber. In some embodiments, each of the plurality of upward baffles may comprise a first end having a first diameter, and a second end having a second diameter, wherein the first diameter may be larger than the second diameter. In some embodiments, the second end of each of the plurality of upward baffles may be located below the first end. In some embodiments, the first diameter may correspond to an inner diameter of the tubular body. In some embodiments, each of the plurality of upward baffles may comprise a plurality of openings. In some embodiments, each of the plurality of downward baffles may comprise a first end having a first diameter, and a second end having a second diameter, wherein the first diameter may be larger than the second diameter. In some embodiments, the second end of the plurality of downward baffles may be located above the first end. In some embodiments, the separator may further comprise a gap between the first end of each of the plurality of downward baffles and an inner wall of the tubular body. In some embodiments, the vertical cylinder may be configured to direct the flow of water from the inlet chamber to a lower portion of the sump chamber. In some embodiments, the vertical cylinder sections may comprise alignment castellations configured to align adjacent vertical riser sections. In some embodiments, the alignment castellations may comprise a plurality of grooves and a plurality of protrusions. In some embodiments, the alignment castellations may comprise a plurality of tabs and a plurality of slots. In some embodiments, the alignment castellations of a first vertical riser section may be configured to interlock with the alignment castellations of a second vertical riser section. In some embodiments, each of the plurality of upward baffles and each of the plurality of downward baffles may comprise a marking. In some embodiments, the bypass weir may comprise at least one weir tab configured to secure the bypass weir to an inner wall of the tubular body. In some embodiments, the vertical riser may comprise a brace configured to secure the bypass weir. In some embodiments, the plurality of upward baffles may comprise three upward baffles and the plurality of downward baffles may comprise three downward baffles.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure, and together with the description, serve to explain the principles of the disclosed embodiments.

FIG. 1 depicts a separator with a plurality of alternating baffles, according to disclosed embodiments.

FIG. 2A depicts a side view of a separator with a plurality of alternating baffles, according to disclosed embodiments.

FIG. 2B depicts a rear view of a separator with a plurality of alternating baffles, according to disclosed embodiments.

FIG. 3 depicts a section cut of a separator with a plurality of alternating baffles, according to disclosed embodiments.

FIG. 4A depicts a plurality of connected alternating baffles, according to disclosed embodiments.

FIG. 4B depicts a section cut of a plurality of connected alternating baffles, according to disclosed embodiments

FIG. 5 depicts an enlarged view of a portion of the plurality of connected alternating baffles, according to disclosed embodiments.

FIG. 6A depicts an enlarged section cut of a vertical cylinder with a plurality of alternating baffles, according to disclosed embodiments.

FIG. 6B depicts an enlarged section cut of a vertical cylinder with a plurality of alternating baffles, according to disclosed embodiments.

FIG. 6C depicts an enlarged view of an interlocking mechanism of a plurality of alternating baffles, according to disclosed embodiments.

FIG. 6D depicts an enlarged view of an interlocking mechanism of a plurality of alternating baffles, according to disclosed embodiments.

FIG. 6E depicts a plurality of markings on a plurality of alternating baffles to aid in assembly, according to disclosed embodiments.

FIG. 7 depicts an enlarged view of a vertical cylinder with an upper cone and a plurality of alternating baffles, according to disclosed embodiments.

FIG. 8A depicts an enlarged view of an anti-nest feature on one of the plurality of alternating baffles, according to disclosed embodiments.

FIG. 8B depicts an enlarged view of an anti-nest feature on a vertical riser, according to disclosed embodiments.

FIG. 8C depicts a spacer configured to space apart the first upward baffle and the upper cone, according to disclosed embodiments.

FIG. 8D depicts a spacer and vertical riser, according to disclosed embodiments.

FIG. 9A depicts an enlarged top view of an upward baffle, according to disclosed embodiments.

FIG. 9B depicts an enlarged view of an upward baffle, according to disclosed embodiments.

FIG. 10 depicts an upward baffle, according to disclosed embodiments.

FIG. 11A depicts an enlarged view of an upper cone, weir, and vertical riser according to disclosed embodiments.

FIG. 11B depicts an enlarged view of a weir connected to a vertical riser, according to disclosed embodiments.

FIG. 12A depicts an upper cone installed over a plastic bracket, according to disclosed embodiments.

FIG. 12B depicts a metal bracket, according to disclosed embodiments.

FIG. 12C depicts a flap on one of a plurality of alternating baffles, according to disclosed embodiments.

FIG. 13A depicts a mounting frame for mounting a plurality of alternating baffles to a manhole structure, according to disclosed embodiments.

FIG. 13B depicts a pocket on one of the plurality of alternating baffles for connecting to the mounting frame of FIG. 13A, according to disclosed embodiments.

FIG. 14A depicts a separator with plate extensions around the plurality of alternating baffles, according to disclosed embodiments.

FIG. 14B depicts a plate extension, according to disclosed embodiments.

FIG. 14C depicts an enlarged view of a plate extension connection to a baffle, according to disclosed embodiments.

FIG. 15 depicts a trash screen installed around a vertical cylinder, according to disclosed embodiments.

FIG. 16 depicts dimensional measurements of a separator, according to disclosed embodiments.

FIGS. 17A-17D depict an enlarged section cut of a separator with a plurality of parallel baffles, according to disclosed embodiments.

FIGS. 18A-18D depict an enlarged section cut of a separator with a plurality of parallel baffles of varying widths, according to disclosed embodiments.

FIGS. 19A-19D depict an enlarged section cut of a separator with a plurality of non-parallel baffles, according to disclosed embodiments.

FIGS. 20A-20D depict an enlarged section cut of a separator with a plurality of non-parallel baffles of varying widths, according to disclosed embodiments.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing hydrodynamic separators by providing a separator with an upper cone and a plurality of alternating baffles located in the sump chamber of the separator. The plurality of alternating baffles of the disclosed embodiments may increase the surface area of the baffles within the sump chamber of the separator which may improve settling of particulate matter from the flow of stormwater. Additionally, the disclosed embodiments may neutralize the velocity of the flow of stormwater entering the sump chamber of the separator which may improve the settling of particulate matter from the flow of stormwater. The disclosed embodiments may further mitigate the risk of resuspended sediment short circuiting to the outlet under high flow conditions.

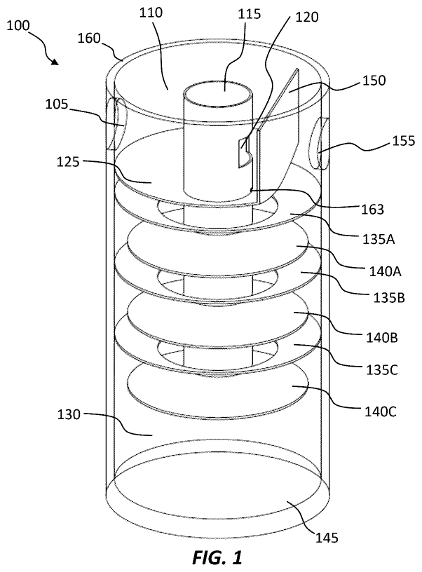

FIG. 1 depicts separator 100, in accordance with disclosed embodiments. Separator 100 may include tubular body 160, which may enclose a flow of stormwater within separator 100. In some embodiments, tubular body 160 may comprise a manhole. Tubular body 160 may extend upwardly from base 145 and may comprise inlet 105 and outlet 155. In some embodiments, a diameter of tubular body 160 may range from about 3 feet to about 12 feet. In other embodiments, the diameter of tubular body 160 may be less than about 3 feet or greater than about 12 feet. In some embodiments, a height of tubular body 160 may be greater than about 4 feet. In other embodiments, the height of tubular body 160 may be about 4 feet or less. Separator 100 may be provided in a variety of sizes based on the flow conditions and site conditions separator 100 is installed in. For example, as provided in Table 1 herein, tubular body 160 of separator 100 may comprise a three-foot, four-foot, five-foot, six-foot, eight-foot, or ten-foot diameter. The sizes of the other components of separator 100, as disclosed herein, may vary based on the size of tubular body 160.

Inlet 105 may comprise an opening in a wall of tubular body 160, which may allow a flow of stormwater to enter separator 100. In some embodiments, as depicted in FIG. 1, tubular body 160 may comprise one inlet 105. In other embodiments (not shown), tubular body 160 may comprise a plurality of inlets 105 which may be spaced apart from one another around the circumference of tubular body 160. The plurality of inlets 105 may be spaced equidistantly apart in some embodiments. In other embodiments, the distances between adjacent inlets 105 may vary. In such an embodiment, the plurality of inlets may be at a similar height on tubular body 160 or may be at varying heights on tubular body 160. Outlet 155 may comprise an opening in the wall of tubular body 160 that may allow a flow of treated stormwater to exit separator 100. In some embodiments, an inflow pipe may be installed through inlet 105 to direct a flow of stormwater into separator 100 from a source. In some embodiments, an outflow pipe may be installed through outlet 155 to direct a flow of treated stormwater from within separator 100 to other components in a stormwater management system. In some embodiments, inlet 105 and outlet 155 may include features that may extend from an outward surface of tubular body 160. In such embodiments (not shown), an inflow pipe and/or an outflow pipe may be connected to separator 100 by surrounding or attaching to the features extending from the outward surface of tubular body 160.

Separator 100 may further include inlet chamber 110 and sump chamber 130 separated by upper cone 125. Inlet chamber 110 may contain a flow of stormwater that enters separator 100 through inlet 105. Sump chamber 130 may receive the flow of stormwater from inlet chamber 110 and allow sediment and particulates to settle out of the flow of stormwater at base 145 of sump chamber 130, as disclosed herein.

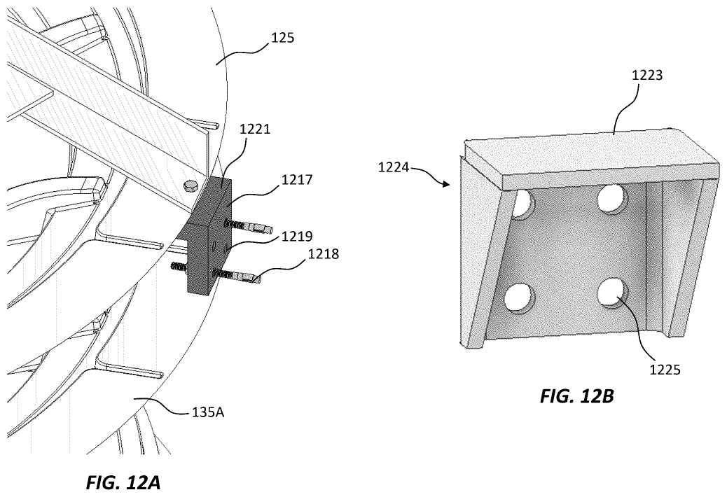

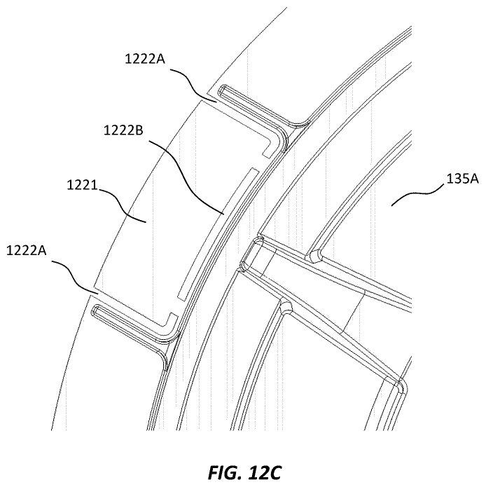

Upper cone 125 may separate inlet chamber 110 from sump chamber 130. Upper cone 125 may comprise a cone-shape with a first end and a second end. In some embodiments, the first end and the second end of upper cone 125 may be circular in shape. The first end may comprise a larger diameter than the second end of upper cone 125. Upper cone 125 may be oriented in tubular body 160 such that the larger first end is located above the smaller second end. The larger first end of upper cone 125 may contact the inner walls of tubular body 160 to create a barrier between inlet chamber 110 and sump chamber 130. A diameter of the larger first end of upper cone 125 may correspond to the diameter of tubular body 160. In some embodiments, the diameter of the larger first end of upper cone 125 may be greater than or less than a diameter of tubular body 160. For example, in some embodiments, a diameter of the larger first end of upper cone 125 may range from about 3 feet to about 12 feet. In other embodiments, the diameter of the larger first end of upper cone 125 may be less than about 3 feet or greater than about 12 feet. In some embodiments, upper cone 125 may be attached to the inner wall of tubular body 160. For example, upper cone 125 may be mounted to the inner wall of tubular body 160 using a mounting bracket or any other form of attachment, as disclosed herein with respect to FIGS. 12A-12B.

Upper cone 125 may further comprise a bypass weir 150 located at the first end of upper cone 125. Bypass weir 150 may block outlet 155 to prevent a flow of stormwater in inlet chamber 110 from exiting separator 100 through outlet 155 up to a predetermined flow rate. If the flow of stormwater into inlet chamber 110 exceeds the predetermined flow rate, then bypass weir 150 may allow the flow of stormwater to bypass sump region 130 and exit inlet chamber 110 through outlet 155. For example, bypass weir 150 may extend upwardly from upper cone 125 and cover outlet 155 from inlet chamber 110. Bypass weir 150 may also provide an opening between upper cone 125 and the inner walls of tubular body 160 to allow the stormwater to exit sump chamber 130 through outlet 155.

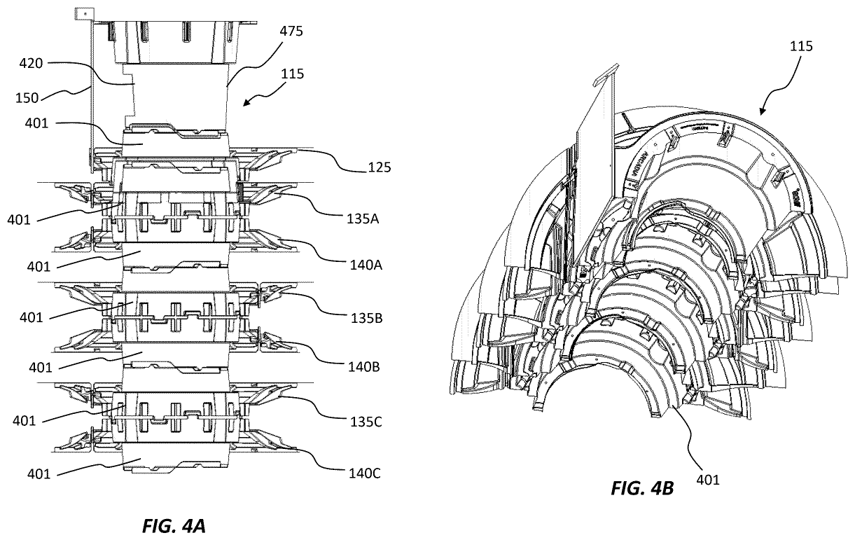

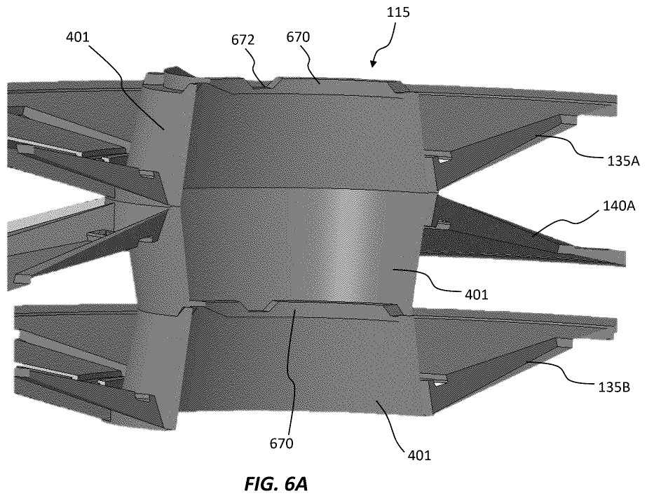

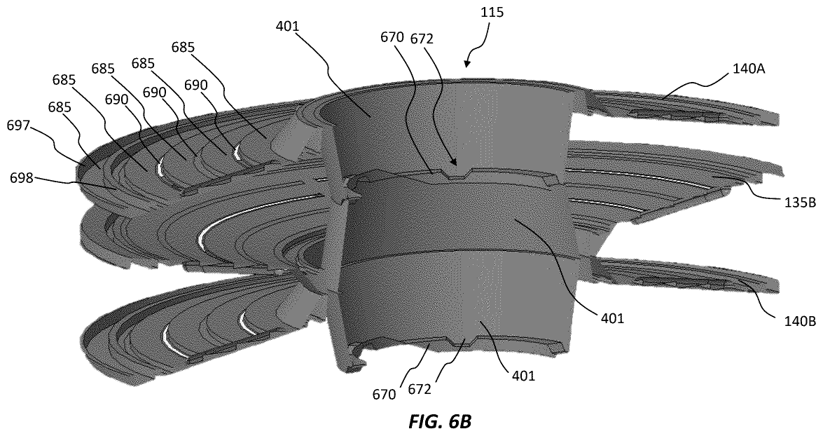

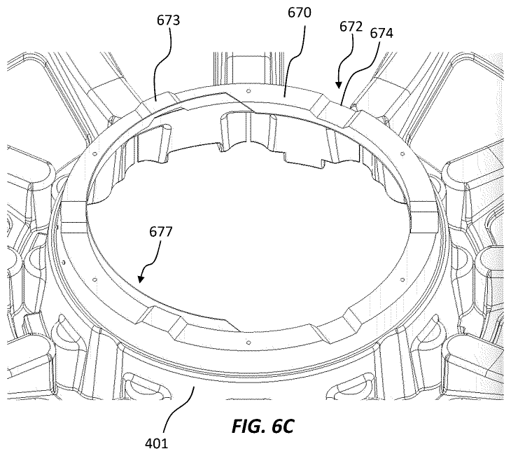

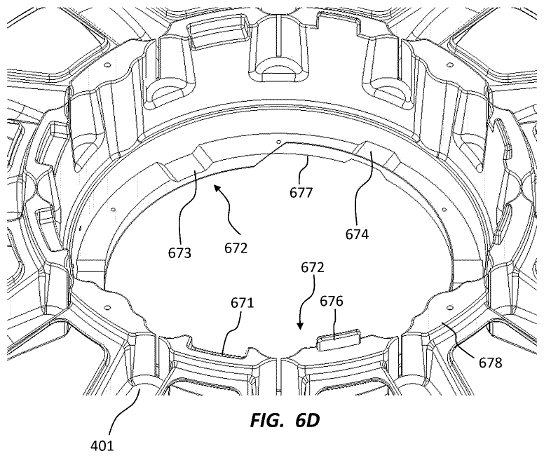

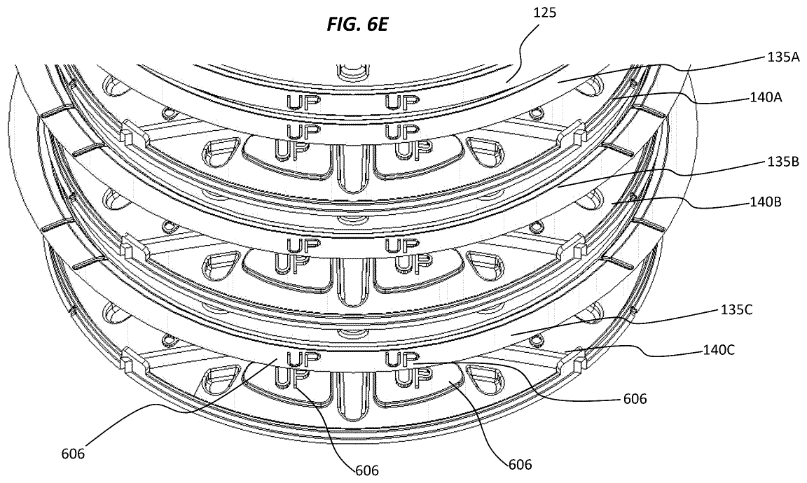

Separator 100 may further include vertical cylinder 115. Vertical cylinder 115 may extend between inlet chamber 110 and sump chamber 130 and may facilitate the flow of stormwater from inlet chamber 110 to sump chamber 130. In some embodiments, as disclosed herein with respect to FIGS. 4A-4B and 6A-6D, vertical cylinder 115 may be formed from a plurality of connected vertical cylinder sections 401. Vertical cylinder 115 may neutralize the velocity of the stormwater as it flows through vertical cylinder 115 to sump chamber 130 from inlet chamber 110. Vertical cylinder 115 may include an inlet port 120 and drain port 163. Inlet port 120 may comprise an opening in vertical cylinder 115 that may allow the flow of stormwater to enter vertical cylinder 115 from inlet chamber 110 and flow downwardly to sump chamber 130. Drain port 163 may comprise an opening in vertical cylinder 115 above upper cone 125 that may allow settled sediment to be washed to sump chamber 130 during cleanout. In some embodiments, drain port 163 may comprise a circular opening in vertical cylinder 115. For example, in some embodiments, drain port 163 may comprise a circular opening with a diameter of one inch. In other embodiments, a diameter of a circular drain port 163 may be greater than or less than one inch. In other embodiments, drain port 163 may be rectangular, square, elliptical, or any other shape opening. For example, during use of separator 100, sediment and particulates may settle out of the flow of stormwater to the base of upper cone 125 within inlet chamber 110. Drain port 163 may allow the settled sediment and particulates to be washed through vertical cylinder 115 into sump chamber 130 to facilitate cleanout of separator 100. Although FIG. 1 depicts one drain port 163, vertical cylinder 115 may include more than one drain port.

Upper cone 125 may be molded to vertical cylinder 115 at the smaller second end of upper cone 125. In some embodiments, vertical cylinder 115 may comprise a corrugated-walled tubular body. In other embodiments, vertical cylinder 115 may comprise a smooth-walled tubular body. In some embodiments, as depicted in FIG. 1, vertical cylinder 115 may comprise a circular cylinder. In other embodiments, vertical cylinder 115 may comprise a polygonal cylinder. For example, vertical cylinder 115 may be pentagonal, hexagonal, octagonal, or any other polygonal shape.

Separator 100 may further include sump chamber 130, which may contain a flow of stormwater from inlet chamber 110 and may allow for sediment and other particulates to settle from the stormwater at base 145 of separator 100. Sump chamber 130 may include a plurality of upward baffles 135A-135C and downward baffles 140A-140C. Each of upward baffles 135A-135C and downward baffles 140A-140C may include first ends and second ends. In some embodiments, the first ends and second ends may be circular in shape. The first ends may comprise a larger diameter than the second ends. Upward baffles 135A-135C may be oriented such that the larger first ends are above the smaller second ends. The larger first ends of upward baffles 135A-135C may extend towards tubular body 160 of separator 100. In some embodiments, the larger first ends of upward baffles 135A-135C may contact the inner wall of tubular body 160. In other embodiments, there may be a gap between the larger first ends of upward baffles 135A-135C and the inner wall of tubular body 160. In some embodiments, the gap between the larger first ends of upward baffles 135A-135C and the inner wall of tubular body 160 may be between about 0.5 inches and two inches. In other embodiments, the gap may be less than 0.5 inches or greater than two inches. Downward baffles 140A-140C may be oriented such that the larger first ends are below the smaller second ends. The second ends of downward baffles 140A-140C may be attached to vertical cylinder 115. In some embodiments, one or more of upward baffles 135A-135C and/or one or more of downward baffles 140A-140C may be attached to the inner wall of tubular body 160. For example, one or more of upward baffles 135A-135C and/or one or more of downward baffles 140A-140C may be mounted to the inner wall of tubular body 160 using a mounting bracket or any other form of attachment. An angle, extending from a vertical axis of vertical cylinder 115, of upward baffles 135A-135C and downward baffles 140A-140C may be between 0 degrees to about 65 degrees. For example, in some embodiments, upward baffles 135A-135C could be situated horizontally if the angle were 0 degrees. Similarly, in some embodiments, downward baffles 140A-140C may be situated horizontally if the angle were 0 degrees. In other embodiments, an angle of upward baffles 135A-135C and downward baffles 140A-140C may be about 20 degrees.

Upward baffles 135A-135C and downward baffles 140A-140C may be stacked vertically in an alternating pattern. A distance between adjacent upward baffles 135A-135C and downward baffles 140A-140C may vary depending on flow rates of the stormwater and the height of tubular body 160. For example, in some embodiments, spacing between adjacent upward baffles 135A-135C and downward baffles 140A-140C may range from about 2 inches to about 13 inches. In other embodiments, spacing between adjacent upward baffles 135A-135C and downward baffles 140A-140C may be 5.5 inches. In other embodiments, the spacing between adjacent upward baffles 135A-135C and downward baffles 140A-140C may be less than 2 inches or greater than 13 inches. Although FIG. 1 depicts three upward baffles 135A-135C and three downward baffles 140A-140C, any number of upward baffles and downward baffles may be included in separator 100.

The flow of stormwater may exit vertical cylinder 115 within sump chamber 130 and flow upwardly through the alternating upward baffles 135A-135C and downward baffles 140A-140C. Upward baffles 135A-135C and downward baffles 140A-140C may reduce the velocity of the flow of stormwater, which may increase the amount of particulates and sediment that may settle from the stormwater within sump chamber 130. The use of upward baffles 135A-135C and downward baffles 140A-140C may also provide more surface area within sump chamber 130 to facilitate settling of particulates and sediment from the stormwater. Upward baffles 135A-135C and downward baffles 140A-140C may also mitigate the risk of resuspended sediment short-circuiting to outlet 155 under high flow conditions. The sediment and particulates may settle out of the stormwater within sump chamber 130 and accumulate at base 145 of tubular body 160. The flow of treated stormwater may then exit sump chamber 130 through outlet 155 by flowing vertically through tubular body 160.

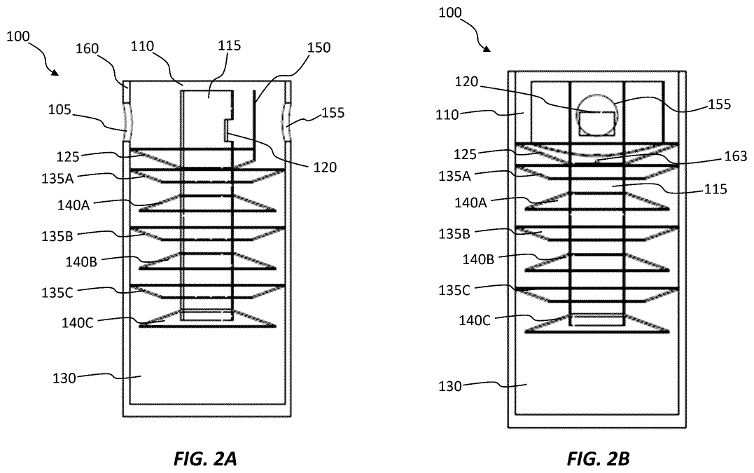

FIG. 2A depicts a side view of separator 100. As depicted in FIG. 2A, upper cone 125 may be attached to vertical cylinder 115 at the smaller end of upper cone 125. Upper cone 125 may extend between the inner walls of tubular body 160 to separate inlet chamber 110 from sump chamber 130. As further depicted in FIG. 2A, the smaller ends of downward baffles 140A-140C may be attached to vertical cylinder 115. In some embodiments, downward baffles 140A-140C may not extend to the inner wall of tubular body 160, and there may be a gap between the larger end of downward baffles 140A-140C and the inner wall of tubular body 160. For example, in some embodiments, a gap between the larger end of downward baffles 140A-140C and the inner wall of tubular body 160 may be about three inches. In other embodiments, the gap between the larger end of downward baffles 140A-140C and the inner wall of tubular body 160 may be greater than or less than three inches. In other embodiments, the larger end of downward baffles 140A-140C may be attached to the inner wall of tubular body 160. In such an embodiment, there may be a gap between vertical cylinder 115 and the smaller ends of downward baffles 140A-140C.

As also depicted in FIG. 2A, in some embodiments, the larger ends of upward baffles 135A-135C may extend towards the inner wall of tubular body 160. As depicted in FIG. 2A, the larger ends of upward baffles 135A-135C may contact the inner wall of tubular body 160. In other embodiments, there may be a gap between the larger ends of upward baffles 135A-135C and the inner wall of tubular body 160. In some embodiments, the gap between the larger ends of upward baffles 135A-135C and the inner wall of tubular body 160 may be between about 0.5 inches and two inches. In other embodiments, the gap may be less than 0.5 inches or greater than two inches. There may be a gap between vertical cylinder 115 and the smaller ends of upward baffles 135A-135C. In some embodiments, the gap between vertical cylinder 115 and the smaller ends of upward baffles 135A-135C may be about six inches. In other embodiments, the gap between vertical cylinder 115 and the smaller ends of upward baffles 135A-135C may be greater than or less than about six inches. In other embodiments, the smaller ends of upward baffles 135A-135C may be attached to vertical cylinder 115. In such embodiments, upward baffles 135A-135C may not extend to the inner wall of tubular body 160, and there may be a gap between the larger end of upward baffles 135A-135C and the inner wall of tubular body 160.

As depicted in FIG. 2A, an upward baffle, such as upward baffle 135A may be located directly beneath upper cone 125. Upward baffles 135A-135C and downward baffles 140A-140C may then alternate downwardly. However, in other embodiments, one of downward baffles 140A-140C may be located directly beneath upper cone 125. In such embodiments, downward baffles 140A-140C and upward baffles 135A-135C may alternate downwardly. Particulates and sediment may settle from the flow of stormwater as the stormwater flows upwardly through upward baffles 135A-135C and downward baffles 140A-140C. The pattern of alternating upward baffles 135A-135C and downward baffles 140A-140C may allow particulates that settle from the flow of stormwater onto upward baffles 135A-135C and/or downward baffles 140A-140C to slide downwardly along the baffles towards base 145 of sump region 130. Accordingly, the pattern of alternating upward baffles 135A-135C and downward baffles 140A-140C may create a downward path towards base 145 of sump region 130 for settled particulates and sediment.

FIG. 2B depicts a rear view of separator 100. As depicted in FIG. 2B, vertical cylinder 115 may include inlet port 120, which may include a rectangular opening in vertical cylinder 115 that may allow stormwater to flow from inlet chamber 110 to sump chamber 130. In other embodiments, inlet port 120 may be square, circular, ovular, or any other shape. Vertical cylinder 115 further includes drain port 163. Drain port 163 may comprise an opening in vertical cylinder 115 that may allow settled sediment to be washed to sump chamber 130. Although FIG. 2B depicts one drain port 163, vertical cylinder 115 may include more than one drain port 163. The flow of stormwater may exit sump chamber 130 through outlet 155 after flowing in a vertical direction through upward baffles 135A-135C and downward baffles 140A-140C.

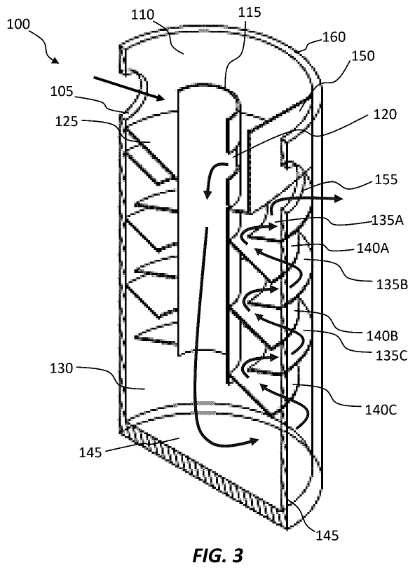

FIG. 3 depicts a flow of stormwater through separator 100. As depicted in FIG. 3, stormwater may flow into inlet chamber 110 of separator 100 through inlet 105. The flow of stormwater may be maintained within inlet chamber 110 by upper cone 125, which may separate inlet chamber 110 from sump chamber 130. The flow of stormwater may flow from inlet chamber 110 to vertical cylinder 115 through inlet port 120 of vertical cylinder 115. The stormwater may flow downward through vertical cylinder 115 from inlet chamber 110 to sump chamber 130. Sediment and particulates may settle out of the flow of stormwater in sump chamber 130. The flow of stormwater may then flow upwardly through the alternating upward baffles 135A-135B and downward baffles 140A-140C of sump chamber 130. For example, the flow of stormwater may flow through the gaps between the larger end of downward baffles 140A-140C and the inner wall of tubular body 160 and through the gaps between the smaller end of upward baffles 135A-135C and vertical cylinder 115. Upward baffles 135A-135C and downward baffles 140A-140C may reduce the velocity of the flow of stormwater, which may increase the amount of particulates and sediment that may settle from the stormwater within sump chamber 130. The use of upward baffles 135A-135C and downward baffles 140A-140C may also provide more surface area within sump chamber 130 to facilitate settling of particulates and sediment from the stormwater. Upward baffles 135A-135C and downward baffles 140A-140C may also mitigate the risk of resuspended sediment short-circuiting to outlet 155 under high flow conditions. For example, upward baffles 135A-135C and downward baffles 140A-140C may prevent sediment and particulates from flowing upwardly within sump region 130 to outlet 155. The sediment and particulates may settle out of the stormwater within sump chamber 130 and accumulate at base 145 of tubular body 160. Additionally, floatable grease, oil, and hydrocarbons may be captured under downward baffles 140A-140C. The flow of treated stormwater may then exit sump chamber 130 through outlet 155.

FIG. 4A depicts a section cut of connected alternating upward baffles 135A-135C and downward baffles 140A-140C, upper cone 125, and vertical riser 475. As depicted in FIG. 4A, each of upward baffles 135A-135C, downward baffles 140A-140C, upper cone 125, and vertical riser 475 may include vertical cylinder section 401. For example, upward baffles 135A-135C and downward baffles 140A-140C may extend outwardly from an outer wall of vertical cylinder section 401. In some embodiments, each of upward baffles 135A-135C and downward baffles 140A-140C may be molded to a vertical cylinder section 401. Each vertical cylinder section 401 may include a larger end and a smaller end. In some embodiments, each of the larger end and the smaller end of vertical cylinder section 401 may be circular in shape. In other embodiments, each of the larger end and the smaller end of vertical cylinder section 401 may be rectangular, square, elliptical, polygonal, or any other shape. The walls of vertical cylinder section 401 may taper from the larger end inwardly towards the smaller end. Vertical cylinder sections 401 may be attached together to form vertical cylinder 115, through which a flow of stormwater may flow, as disclosed herein.

In some embodiments, as disclosed herein, the upper portion of vertical cylinder 115 above upper cone 125 may be formed from vertical riser 475. Vertical riser 475 may include a larger end and a smaller end. In some embodiments, the larger end and the smaller end of vertical riser 475 may be circular in shape. In other embodiments, each of the larger end and the smaller end of vertical riser 475 may be rectangular, square, elliptical, polygonal, or any other shape. The walls of vertical riser 475 may taper from the larger end inwardly towards the smaller end. Vertical riser 475 may attach to a vertical cylinder section 401. For example, vertical riser 475 may attach to vertical cylinder section 401 that is molded with upper cone 125. Vertical riser 475 may include inlet port 420, which may correspond to inlet port 120, as disclosed herein with respect to FIG. 1. For example, inlet port 420 may comprise an opening in vertical riser 475 that may allow the flow of stormwater to enter vertical riser 475 from inlet chamber 110 and flow downwardly to sump chamber 130 through vertical cylinder 115 formed by connected vertical cylinder sections 401. As depicted in FIG. 4A and FIG. 4B, vertical cylinder 115 may have an undulating profile formed from the alternating inwardly and outwardly tapered sections of connected vertical cylinder sections 401.

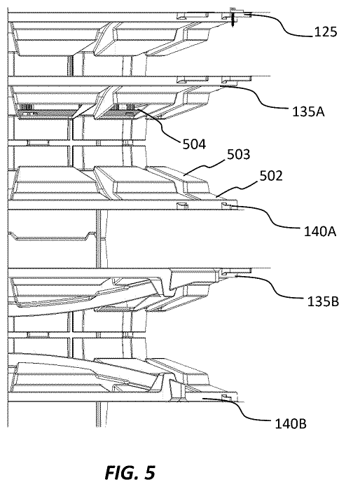

As depicted in FIG. 5, each of downward baffles 140A-140C may include protrusions 503. Protrusions 503 may extend upwardly from an upper surface of downward baffles 140A-140C. Protrusions 503 may facilitate the settling of sediments out of the flow of water as it moves through the pattern of alternating upward baffles 135A-135C and downward baffles 140A-140C. Protrusions 503 may also provide additional structural strength and rigidity to downward baffles 140A-140C. As depicted in FIG. 5, protrusions 503 may be trapezoidal in shape. In other embodiments, protrusions 503 may be square, rectangular, circular, elliptical, or any other shape. As further depicted in FIG. 5, outer edge 502 of downward baffles 140A-140C may be flat and may not include protrusion 503. Each of upward baffles 135A-135C may include openings 504. Openings 504 may comprise openings through the surface of upward baffles 135A-135C through which stormwater may flow. As disclosed herein, upward baffles 135A-135C may include a plurality of openings 504 extending around the surface of upward baffles 135A-135C. Additionally or alternatively, in some embodiments (not depicted in FIG. 5), each of downward baffles 140A-140C may have openings 504.

As further depicted in FIGS. 6A-6D, vertical cylinder 115 may be formed from a plurality of connected vertical cylinder sections 401. For example, in some embodiments, upward baffles 135A-135C, downward baffles 140A-140C, and upper cone 125 may be molded to a vertical cylinder section 401. Each vertical cylinder section 401 may include a larger end and a smaller end. In some embodiments, each of the larger end and the smaller end of vertical cylinder section 401 may be circular in shape. In other embodiments, each of the larger end and the smaller end of vertical cylinder section 401 may be rectangular, square, elliptical, polygonal, or any other shape. The walls of vertical cylinder section 401 may taper from the larger end inwardly towards the smaller end. Vertical cylinder sections 401 of adjacent upward baffles and downward baffles may be attached to form vertical cylinder 115, through which a flow of stormwater may flow, as disclosed herein. For example, vertical cylinder sections 401 may be attached by flanges 670. Flanges 670 may include a protruding lip, ridge, or rim that may extend either inwardly or outwardly from vertical cylinder sections 401. Each of vertical cylinder sections 401 may be attached at alternating large ends and small ends using flanges 670. In other embodiments, vertical cylinder sections 401 may be attached using screws, bolts, or any other form of attachment.

As depicted in FIG. 6C and FIG. 6D, vertical cylinder sections 401 may further include alignment castellations 672. Alignment castellations 672 may facilitate alignment of adjacent vertical cylinder sections 401 during assembly. For example, alignment castellations 672 may allow for an interlocking of adjacent vertical cylinder sections 401 to ensure that adjacent vertical cylinder sections 401 are properly aligned and connected. FIG. 6C depicts the smaller edge 677 of vertical cylinder section 401. Alignment castellations 672 on the smaller edge 677 of vertical cylinder section 401 may comprise an alternating groove 674 or protrusion 673 from an edge of vertical cylinder section 401. Groove 674 may comprise a trapezoidal cut or depression in the edge of vertical cylinder section 401. Protrusion 673 may comprise a trapezoidal section extending upwardly from the edge of vertical cylinder section 401. In other embodiments, the shape of groove 674 and protrusions 673 may be square, rectangular, or any other shape. The size and shape of grooves 674 and protrusions 673 may be complementary such that the grooves 674 and protrusions 673 of a first vertical cylinder section 401 may interlock with the protrusions 673 and grooves 674 of a second vertical cylinder section 401.

FIG. 6D depicts an underside of the vertical cylinder section 401 shown in FIG. 6C, including both the larger edge 678 and the smaller edge 677 of vertical cylinder section 401. As disclosed herein with respect to FIG. 6C, smaller edge 677 of vertical cylinder sections 401 may include grooves 674 and protrusions 673. Larger edge 678 of vertical cylinder sections 401 may include alignment castellations 672, including tab 676 and slot 671. Tab 676 may comprise an elongated extension that may extend vertically from the surface of larger edge 678. Slot 671 may include a cut or depression into the surface of larger edge 678. The size and shape of tabs 676 and slots 671 may be complementary such that the tabs 676 and slots 671 of a first vertical cylinder section 401 may interlock with the slots 671 and tabs 676 of a second vertical cylinder section 401 oriented in an opposite direction of the first vertical cylinder 401. The differing alignment castellations 672 of larger edge 678 and smaller edge 677 of vertical cylinder sections 401 may aid installers in assembling vertical cylinder 115. For example, the complementary slots 671 and tabs 676 of larger edge 678 may guide an installer to interlock two larger edges 678 of adjacent vertical cylinder sections 401 and the complementary grooves 674 and protrusions 673 of smaller edge 677 may guide an installer to interlock two smaller edges 677 of adjacent vertical cylinder sections 401.

As depicted in FIG. 6E, each of upward baffles 135A-135C, downward baffles 140A-140C, and upper cone 125 may include markings 606. Markings 606 may comprise a depression or a protrusion from the surface of upward baffles 135A-135C, downward baffles 140A-140C, and upper cone 125. Marking 606 may be located on the surface of upward baffles 135A-135C, downward baffles 140A-140C, and upper cone 125 that faces upward when installed within a tubular body, such as tubular body 160 as depicted in FIG. 1. For example, as depicted in FIG. 6E, marking 606 may comprise the word “UP.” In other embodiments, marking 606 may comprise any word, symbol, pattern, or other marking. The location of marking 606 may further guide an installer when assembling separator 100. For example, marking 606 may indicate to an installer the direction in which each of upward baffles 135A-135C, downward baffles 140A-140C, and upper cone 125 should face when assembling separator 100.

Returning to FIG. 6B, baffles, such as downward baffle 140A, may include stepped surfaces 685. Stepped surfaces 685 may comprise surfaces that may extend horizontally or at an angle from vertical cylinder section 401. Stepped surfaces 685 may be separated by grooves 690. Grooves 690 may comprise a vertical step between an upper stepped surface 685 and a lower stepped surface 685. Grooves 690 may further comprise a location where two twin sheets may meet and fuse together during molding to form a twin sheet molded downward baffle 140A. Grooves 690 may extend vertically or at an angle between an upper stepped surface 685 and a lower stepped surface 685, such that stepped surfaces 185 extend downwardly as stepped surfaces 685 extend away from vertical cylinder section 401. While FIG. 6B depicts three grooves 690, downward baffle 140A may include any number of grooves. Downward baffle 140A may further include outer lip 697 and inner lip 698. Outer lip 697 may extend circumferentially around the outer edge of downward baffle 140A. Inner lip 698 may extend circumferentially around the inner edge of the outermost stepped surface 685 of downward baffle 140A. Outer lip 697 and inner lip 698 may extend vertically from the surface of downward baffle 140A. Outer lip 697 and inner lip 698 may provide support to the outer stepped surface 685. Although stepped surfaces 685 and grooves 690 are described with reference to downward baffle 140A, any of upward baffles 135A-135C and/or downward baffles 140A-140C, as depicted in FIG. 1, may include stepped surfaces and grooves.

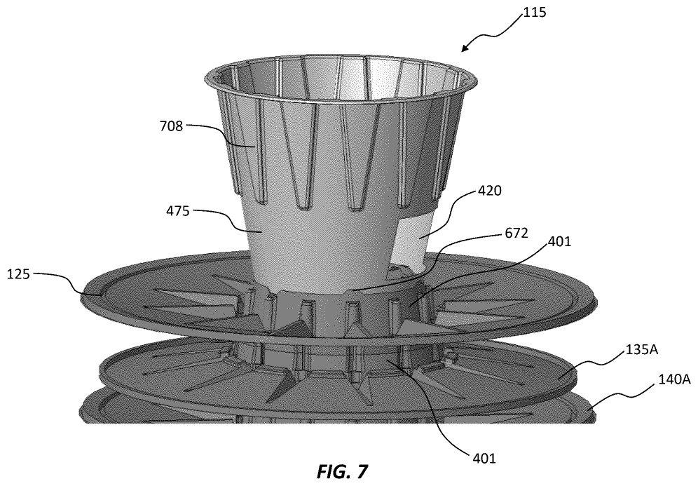

In some embodiments, as depicted in FIG. 7, vertical cylinder 115 may further be formed from connected vertical cylinder sections 401 and vertical riser 475. Vertical riser 475 may include a larger end and a smaller end. In some embodiments, the larger end and the smaller end of vertical riser 475 may be circular in shape. In other embodiments, each of the larger end and the smaller end of vertical riser 475 may be rectangular, square, elliptical, polygonal, or any other shape. The walls of vertical riser 475 may taper from the larger end inwardly towards the smaller end. Vertical riser 475 may attach to a vertical cylinder section 401. For example, vertical riser 475 may attach to vertical cylinder section 401 that is molded with upper cone 125. Vertical cylinder sections 401 that are molded with upward baffles, such as upward baffle 135A, and downward baffles, such as downward baffle 140A, may also be attached to vertical cylinder section 401 that is molded with upper cone 125. As depicted in FIG. 7, vertical riser 475 may further include alignment castellations 672. Alignment castellations 672 may comprise an alternating groove or protrusion from an edge of vertical riser 475. Alignment castellations 672 may facilitate alignment of vertical riser 475 with an adjacent vertical cylinder section 401 during installation. Vertical riser 475 may include inlet port 420. Inlet port 420 may comprise an opening in vertical riser 475 that may allow the flow of stormwater to enter and flow downwardly through the connected vertical cylinder sections 401. Vertical riser 475 may further include ribs 708. Ribs 708 may protrude outwardly from a surface of vertical riser 475 and may provide structural support for vertical riser 475.

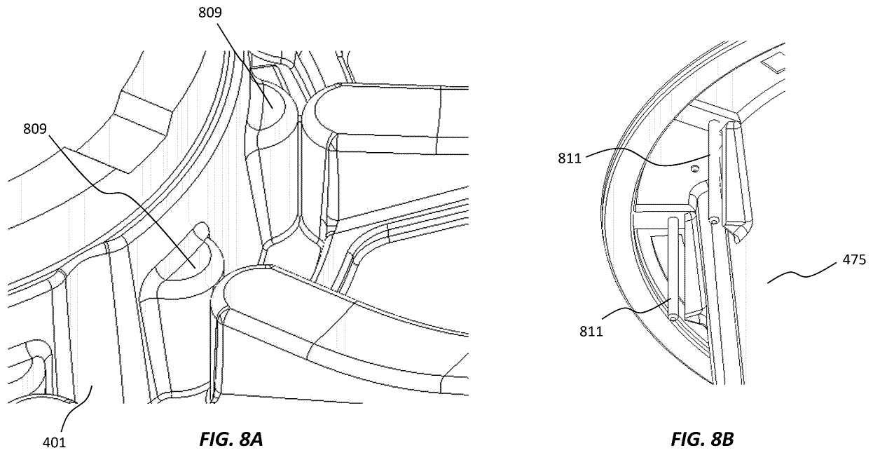

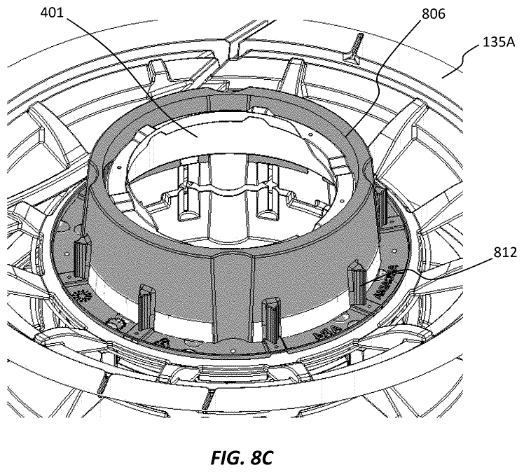

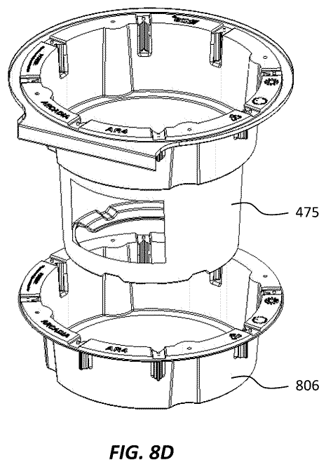

FIGS. 8A and 8B depict anti-nest features on vertical cylinder sections 401 and vertical riser 475. As depicted in FIG. 8A, vertical cylinder section 401 may include anti-nest protrusion 809. Anti-nest protrusion 809 may comprise a semi-circular shaped protrusion that extends outwardly from the outer side of vertical cylinder section 401. Although FIG. 8A depicts a semi-circular shaped protrusion, anti-nest protrusion 809 may be square, rectangular, elliptical, or any other shape. Vertical cylinder section 401 may include a plurality of anti-nest protrusions 809 around the outer circumference of vertical cylinder section 401. Anti-nest protrusions 809 may prevent two adjacent upward baffles or downward baffles from completely nesting when stacked for storage or transportation. For example, multiple upward baffles or downward baffles may be stacked for space efficiency in storage and transportation. However, if the stacked upward baffles or downward baffles completely nest, they may be more difficult to un-stack. Anti-nest protrusion 809 may provide a space between adjacent stacked upward baffles or downward baffles to facilitate un-stacking. For example, anti-nest protrusion 809 of a first upward baffle or downward baffle may abut a bottom edge of a vertical cylinder section 401 of a second upward baffle or downward baffle to provide a space between first and second upward baffles or downward baffles. Similarly, as depicted in FIG. 8B, vertical riser 475 may include anti-nest extension 811. Anti-nest extension 811 may comprise a cylindrical extension from a bottom surface of a top edge of vertical riser 475. Anti-nest extension 811 may provide a space between adjacent stacked vertical risers 475 to facilitate un-stacking of multiple vertical risers 475.

In some embodiments, anti-nest protrusions 809 may further be configured to provide a space between upper cone 125 and first upward baffle 135A when vertical riser 115 is fully assembled. For example, in some embodiments of separator 100, such as a separator 100 with a three-foot, four-foot, five-foot, or six-foot diameter, anti-nest protrusions 809 may further act as a spacer between upper cone 125 and first upward baffle 135A. For example, a bottom edge of upper cone 125 may rest on anti-nest protrusions 809 of upward baffle 135A to provide spacing between upper cone 125 and upward baffle 135A. In other embodiments, such as where separator 100 has an eight-foot or ten-foot diameter, a spacer, such as spacer 806, as depicted in FIG. 8C, may be provided. In other embodiments, a spacer, such as spacer 806, may be provided in a separator 100 with a three-foot, four-foot, five-foot, or six-foot diameter. Spacer 806 may comprise a hollow cylinder with an inner diameter that is complementary to an outer diameter of vertical cylinder section 401. Spacer 806 may be placed around vertical cylinder section 401 of first upward baffle 135A. Upper cone 125 may then be placed over spacer 806. Spacer 806 may include protrusions 812 which may extend outwardly from the outer circumference of spacer 806. Protrusions 812 may extend around a circumference of spacer 806. A bottom edge of upper cone 125 may rest on protrusions 812 to provide space between upper cone 125 and first upward baffle 135A. In some embodiments, as depicted in FIG. 8D, spacer 806 may be molded with vertical riser 475 during the manufacturing process. During assembly and installation, an installer may cut spacer 806 from vertical riser 475 and assemble spacer 806 between upper cone 125 and first upward baffle 135A as described above. Molding spacer 806 and vertical riser 475 together may increase manufacturing efficiencies and allow both pieces to be formed from a single mold. In other embodiments, spacer 806 may be molded separately from vertical riser 475.

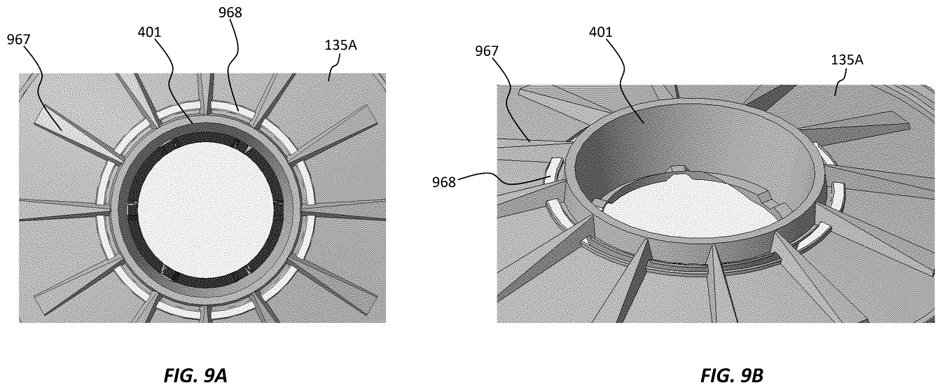

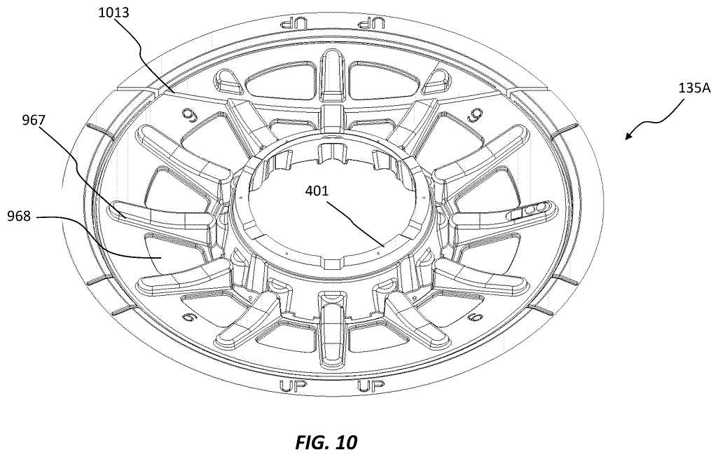

As depicted in FIGS. 9A and 9B, upward baffle 135A may include ribs 967 and opening 968. Opening 968 may facilitate a flow of stormwater upwardly through upward baffle 135A, as disclosed herein. Ribs 967 may provide structural support to baffle 135A and may connect the outer portion of upward baffle 135A with vertical cylinder 401. The size and shape of opening 968 may vary based on the desired flow rate of stormwater through upward baffle 135A. For example, as depicted in FIG. 9A and FIG. 9B, opening 968 may comprise a slot opening through upward baffle 135A. As depicted in FIG. 10, openings 968 may comprise larger openings between ribs 967. Although FIGS. 9A and 9B depict ribs 967 and opening 968 on upward baffle 135A, each of upward baffles 135A-135C, as depicted in FIG. 1, may include ribs and openings.

FIG. 10 depicts upward baffle 135A including ribs 967 and openings 968. As depicted in FIG. 10, ribs 967 may extend outwardly from the surface of upward baffle 135A and may provide structural support and rigidity to upward baffle 135A. Openings 968 may extend between ribs 967 and may allow stormwater to flow through upward baffle 135A, as disclosed herein with respect to FIG. 3. In some embodiments, as depicted in FIG. 10, at least some of openings 968 may be trapezoidal in shape. In other embodiments, openings 968 may be square, rectangular, circular, or any other shape. The size, shape, and configuration of openings 968 may vary based on the desired flow conditions in separator 100. FIG. 10 further depicts slot 1013. Slot 1013 may comprise a depression or groove in the surface of upward baffle 135A. Openings 968 and ribs 967 may extend on both sides of slot 1013. Slot 1013 may be configured to secure a weir, such as bypass weir 150 as depicted in FIG. 1. Although FIG. 10 depicts upward baffle 135A, each of upward baffles 135A-135C may have similar configurations.

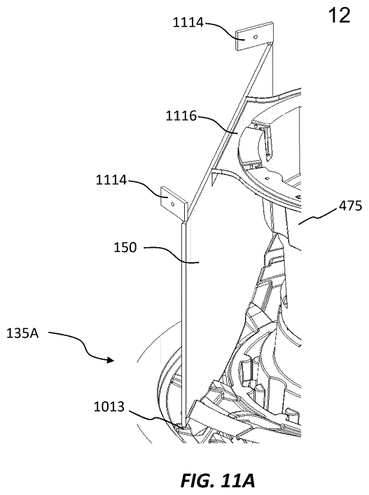

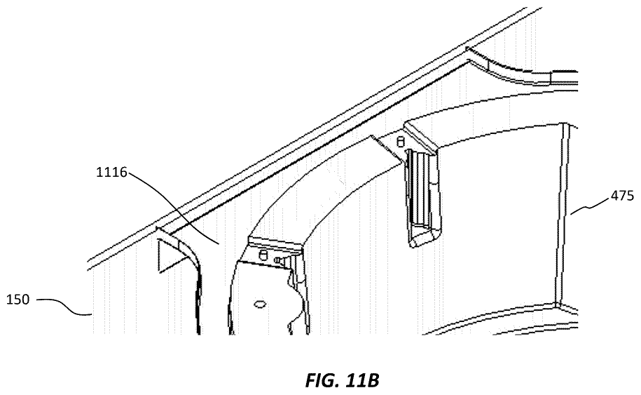

FIG. 11A depicts bypass weir 150 assembled on upper baffle 135A. Bypass weir 150 may be secured within slot 1013 of upper baffle 135A. Bypass weir 150 may further be secured to an inner wall of a tubular body, such as tubular body 160 as disclosed herein with respect to FIG. 1 (tubular body 160 is not depicted in FIG. 11A). For example, weir tabs 1114 may extend outwardly from a top edge of bypass weir 150. Weir tabs 1114 may include living hinges that may allow weir tabs 1114 to be moved to contact an inner surface of tubular body 160. A screw or other fastener may be placed through holes in weir tabs 1114 to connect weir tabs 1114 to the inner surface of tubular body 160. Fastening bypass weir 150 to the inner surface of tubular body 160 by weir tabs 1114 may provide additional support to bypass weir 150 to ensure bypass weir 150 does not detach from its assembled position during use of the separator. Bypass weir 150 may also be connected to vertical riser 475 by brace 1116. For example, as depicted in FIG. 11B, vertical riser 475 may include brace 1116 that may extend horizontally from an upper edge of vertical riser 475. Bypass weir 150 may be further connected to brace 1116 by screws or other fastening methods to provide additional support to bypass weir 150.

FIG. 12A depicts a plastic bracket 1217 and FIG. 12B depicts a metal bracket 1224, which may each be used for installing the assembled upper cone 125, upward baffles 135A-135C, and downward baffles 140A-140C within tubular body 160, as depicted in FIG. 1. When installing the connected upper cone 125, upward baffles 135A-135C, and downward baffles 140A-140C, brackets such as plastic bracket 1217 or metal bracket 1224 may be mounted to an inner surface of tubular body 160. In some embodiments, four plastic brackets 1217 or four metal brackets 1224 may be mounted around the inner circumference of tubular body 160. In other embodiments, more or fewer plastic brackets 1217 or metal brackets 1224 may be mounted around the inner circumference of tubular body 160. Plastic brackets 1217 and metal brackets 1224 may be mounted to the inner circumference of tubular body 160 by screws 1218 or any other fasteners. In some embodiments, plastic brackets 1217 may be formed from polypropylene or any other plastic. In some embodiments, metal brackets 1224 may be formed from steel.

As depicted in FIG. 12A, plastic bracket 1217 may include horizontal shelf 1221 and, as depicted in FIG. 12B, metal bracket 1224 may include horizontal shelf 1223. When installed in tubular body 160, horizontal shelf 1221 and horizontal shelf 1223 may extend inwardly from the inner surface of tubular body 160. Upper cone 125 may rest above horizontal shelf 1221 or horizontal shelf 1223 and may be connected to horizontal shelf 1221 or horizontal shelf 1223 using a screw or any other fastening method. As depicted in FIG. 12A, plastic bracket 1217 may include four holes 1219 through which screws 1218 or other fastening mechanisms may be inserted to secure plastic bracket 1217 to the inner wall of a tubular body. As depicted in FIG. 12B, metal bracket 1224 may include four holes 1225 through which screws, such as screws 1218 as depicted in FIG. 12A, may be inserted to secure metal bracket 1224 to the inner wall of a tubular body. In other embodiments, plastic bracket 1217 may include more or fewer holes 1219 and metal bracket 1224 may include more or fewer holes 1225.

FIG. 12C depicts upward baffle 135A with flap 1221 formed by cutouts 1222A and 1222B. Although FIG. 12C depicts upward baffle 135A, each of upward baffles 135A-135C and downward baffles 140A-140C may include flap 1221 formed by cutouts 1222A and 1222B. In some embodiments, only upward baffles 135A-135C may include flap 1221. Cutouts 1222A and 1222B may form the perimeter of flap 1221 and may create a living hinge to allow deflection of flap 1221 during installation of separator 100.

When installing upward baffles 135A-135C and downward baffles 140A-140C within tubular body 160, plastic bracket 1217 or metal bracket 1224 may be mounted to the inner walls of tubular body 160 before upward baffles 135A-135C and downward baffles 140A-140C are placed within tubular body 160. Accordingly, upward baffles 135A-135C and downward baffles 140A-140C may need to be installed around plastic bracket 1217 or metal bracket 1224, which extends horizontally inwardly from the inner surface of tubular body 160. Accordingly, flap 1221 may deflect around plastic brackets 1217 or metal brackets 1224 within tubular body 160 when upward baffles 135A-135C and downward baffles 140A-140C are lowered into tubular body 160 during installation. After upward baffles 135A-135C and downward baffles 140A-140C pass the plastic bracket 1217 or metal bracket 1224, flap 1221 may return to its original position. When flap 1221 returns to its original position, as depicted in FIG. 12C, it may substantially diminish or minimize water from short circuiting around upward baffles 135A-135C and downward baffles 140A-140C. Each of upward baffles 135A-135C and downward baffles 140A-140C may have any number of flaps 1221. The size and spacing of flaps 1221 may correspond to the size and spacing of plastic brackets 1217 or metal brackets 1224 to allow upward baffles 135A-135C and downward baffles 140A-140C to be installed around plastic brackets 1217 or metal brackets 1224.

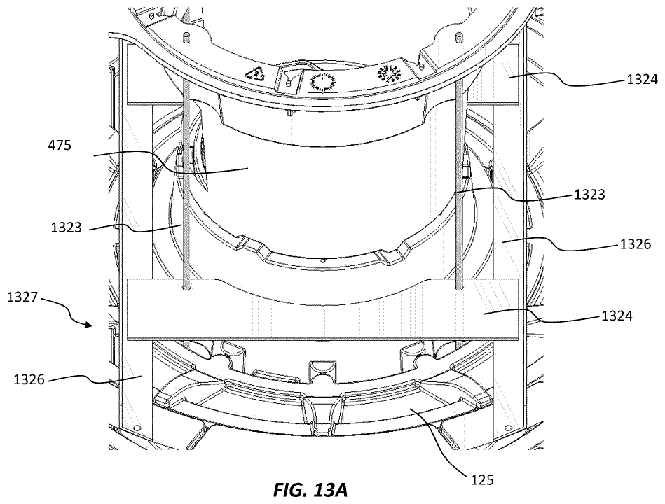

FIG. 13A depicts an enlarged view of support frame 1327. When vertical riser 475, upper cone 125, upward baffles 135A-135C, and downward baffles 140A-140C are assembled, support frame 1327 may secure each of the pieces together and provide support to the assembled structure. Support frame 1327 may comprise a plurality of threaded rods 1323. Threaded rods 1323 may extend downwardly from the top of vertical riser 475 and through each of upper cone 125, upward baffles 135A-135C, and downward baffles 140A-140C. In some embodiments, support frame 1327 may include four threaded rods 1323. In other embodiments, support frame 1327 may include more or fewer threaded rods 1323. Threaded rods 1323 may compress each of upper cone 125, upward baffles 135A-135C, and downward baffles 140A-140C to ensure a tight connection between each of the pieces. In some embodiments, threaded rods 1323 may be formed from stainless steel. In other embodiments, threaded rods 1323 may be formed from any metal or plastic material.

In some embodiments, an alignment tool may be used when assembling upper cone 125, upward baffles 135A-135C, and downward baffles 140A-140C with threaded rods 1323. For example, in some embodiments, upper cone 125, upward baffles 135A-135C, and downward baffles 140A-140C may be assembled using an overhead lifting device such as an overhead crane. The alignment tool may comprise an elongated body with a hook at one end. The hook of the alignment tool may latch to one of threaded rods 1323 during assembly to line up threaded rods 1323 with upper cone 125, upward baffles 135A-135C, and downward baffles 140A-140C as each of upper cone 125, upward baffles 135A-135C, and downward baffles 140A-140C is lowered onto the assembly using the overhead lifting device. The alignment tool may allow installers to avoid reaching any part of their body under a suspended load when adjusting threaded rods 1323.

Support frame 1327 may further comprise horizontal plates 1324 and horizontal braces 1326. Support frame 1327 may comprise two horizontal plates 1324 and two horizontal braces 1326. Each of horizontal plates 1324 may be assembled on opposite sides of vertical riser 475 and may be substantially parallel. Horizontal braces 1326 may also be assembled on opposite sides of vertical riser 475 and may be substantially parallel. Horizontal plates 1324 may be generally perpendicular to horizontal braces 1326. Horizontal plates 1324 may be connected to horizontal braces 1326 by screws, washers and nuts, bolts, or any other fastening mechanisms. As depicted in FIG. 13A, horizontal plates 1324 and horizontal braces 1326 may be assembled above upper cone 125. In other embodiments, horizontal plates 1324 and horizontal braces 1326 may be assembled below upper cone 125. When assembling separator 100, horizontal plates 1324 and horizontal braces 1326 may be secured to fastener 1217, as depicted in FIGS. 12A-12B (fastener 1217 is not shown in FIG. 13A). Accordingly, the weight of upper cone 125, upward baffles 135A-135C, and downward baffles 140A-140C may be transferred to support frame 1327. In some embodiments, horizontal plates 1324 and horizontal braces 1326 may be formed from stainless steel, or any other metal or plastic material.

FIG. 13B depicts an enlarged view of upward baffle 135A including pocket 1328. Although FIG. 13B depicts upward baffle 135A with pocket 1328, each of upward baffles 135A-135C and downward baffles 140A-140C may include pocket 1328. Pocket 1328 may comprise a groove or indentation in the outer surface of vertical cylinder section 401. Pocket 1328 may further include threaded rod opening 1329. Threaded rod opening 1329 may be configured to allow a threaded rod, such as threaded rods 1323, to pass through upward baffles 135A-135C and downward baffles 140A-140C. The indentation within the outer surface of vertical cylinder section 401 formed by pocket 1328 may provide a flat landing spot for a washer and nut to screw to the bottom of threaded rod 1323 below downward baffle 140C. This may allow threaded rods 1323 to be secured to the bottom of the assembled stack of upward baffles 135A-135C and downward baffles 140A-140C.

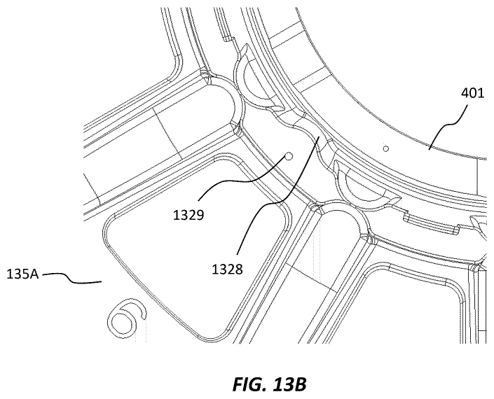

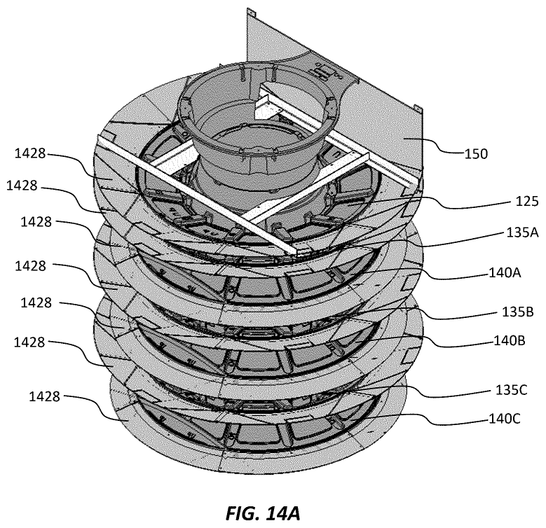

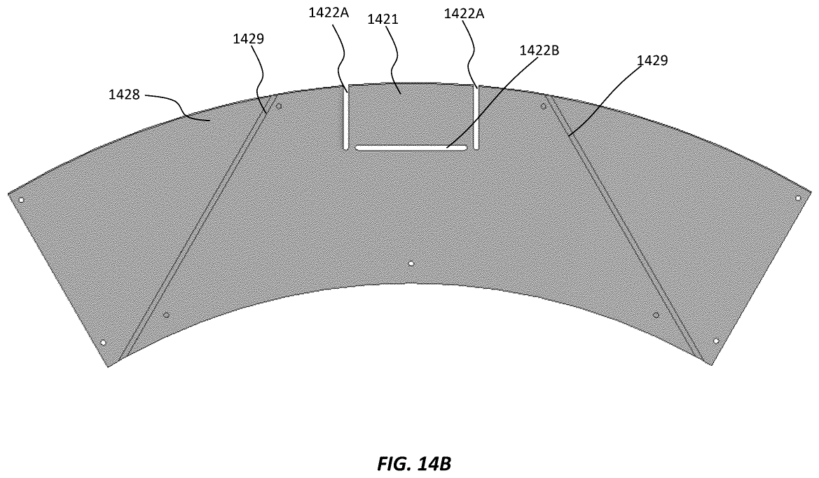

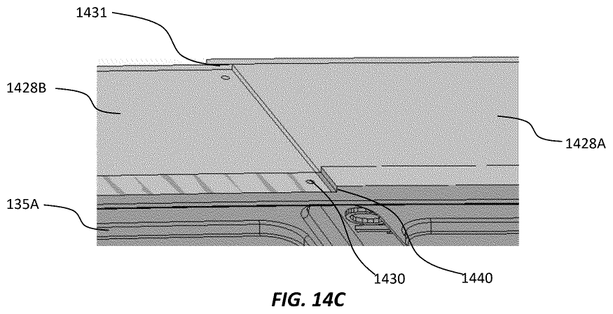

FIG. 14A depicts separator 100 with a plurality of plate extensions 1428 around each upward baffle 135A-135C and downward baffle 140A-140C, according to disclosed embodiments. Plate extensions 1428 may allow separator 100 to be installed within a larger sized tubular body, such as tubular body 160 (not depicted in FIG. 14A) by extending the diameter of upward baffles 135A-135C and downward baffles 140A-140C. For example, in some embodiments, a diameter of the tubular body 160 in which separator 100 will be installed may be 10 feet. In such embodiments, the diameter of upward baffles 135A-135C may be about 93 inches and downward baffles 140A-140C may be about 144 inches. Plate extensions 1428 may be attached to the outer edges of upward baffles 135A-135C and downward baffles 140A-140C such that the diameter of upward baffles 135A-135C with extension plate 1428 may be about 116-120 inches and the diameter of downward baffle 140A-140C with extension plate 1428 may be about 105-109 inches.

As depicted in FIG. 14B, plate extensions 1428 may comprise a flat stock plate. During assembly, plate extensions 1428 may be flexed and interconnected to form a three-dimensional cone segment that may be attached to the outer edges of upward baffles 135A-135C and downward baffles 140A-140C. In some embodiments, as depicted in FIG. 14A, six interconnected plate extensions 1428 may be connected and assembled around each upward baffle 135A-135C and each downward baffle 140A-140C. In other embodiments, more or fewer plate extensions 1428 may be connected to fully extend around the outer circumference of each upward baffle 135A-135C and each downward baffle 140A-140C.

FIG. 14C depicts an enlarged view of a connection between upward baffle 135A and first plate extension 1428A and second plate extension 1428B. When assembling plate extensions around one of upward baffles 135A-135C or downward baffles 140A-140C, a first plate extension 1428A may overlap a second plate extension 1428B, as depicted in FIG. 14C. An outer edge of upward baffles 135A-135C or downward baffles 140A-140C may include indentation 1440. Indentation 1440 may facilitate assembly of first plate extension 1428A and second plate extension 1428B. For example, lap joint 1431 formed by the overlapping of first plate extension 1428A and second plate extension 1428B may align with indentation 1440. This may aid an installer in aligning the interconnected plate extensions 1428 with each of upward baffles 135A-135C or downward baffles 140A-140C. First plate extension 1428A and second plate extension 1428B may be connected to each other and to the edge of each of upward baffles 135A-135C or downward baffles 140A-140C by a fastener, such as a nut and bolt, installed through holes 1430.

Returning to FIG. 14B, plate extensions 1428 may comprise flap 1421 formed by cutouts 1415A and 1415B. In some embodiments, when installing separator 1400 within a tubular body, such as tubular body 160, brackets, such as brackets 1217, may be installed within the tubular body 160 to support separator 1400. Such brackets 1217 may be installed in tubular body 160 before separator 1400 is placed within the tubular body 160 and may extend inwardly towards the center of the tubular body 160. Flap 1421 may deflect around the brackets 1217 within the tubular body 160 when separator 1400 is lowered into the tubular body 160 during installation. After plate extension 1428 passes the bracket 1217, flap 1421 may return to its original position. When flap 1421 returns to its original position, as depicted in FIG. 14B, it may substantially diminish or minimize water from short circuiting around plate extension 1428. In some embodiments, plate extensions 1428 may not include flap 1421 formed by cutouts 1415A and 1415B.

Plate extension 1428 may also include notches 1429. Notches 1429 may provide a guide for an installer and may indicate a location to cut plate extension 1428. For example, when plate extension 1428 is assembled around upper cone 125, as depicted in FIG. 14A, plate extension 1428 may need to be cut to allow for assembly of bypass weir 150.

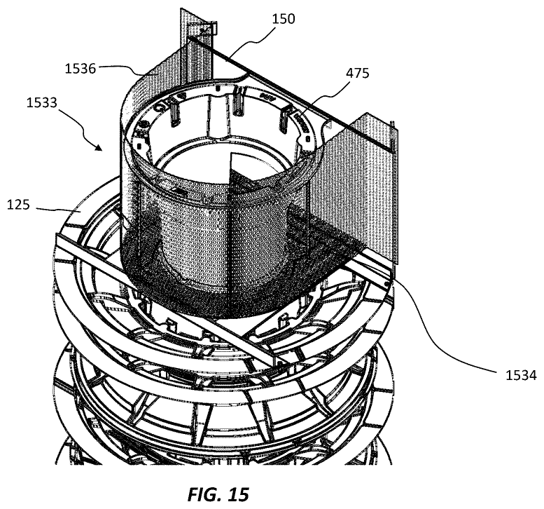

In some embodiments, separator 100 may further include screen 1533, as depicted in FIG. 15. Screen 1533 may be configured to prevent trash from entering sump region of separator 100 through the inlet port 420 of vertical riser 475. Screen 1533 may comprise a stainless steel perforated plate with a 5 mm hole size. Screen 1533 may comprise horizontal section 1534 and vertical section 1536. Horizontal section 1534 of screen 1533 may be installed below vertical riser 475 and above upper cone 125. Horizontal section 1534 may include a hole in the center that may be configured to extend around vertical riser 475, to prevent trash from entering vertical riser 475. Vertical section 1536 may comprise a substantially horseshoe shape and may extend vertically from horizontal section 1534. For example, vertical section 1536 may wrap around vertical riser 475 and be attached to bypass weir 150 and an inner wall of the tubular body, such as tubular body 160. A height of vertical cylinder section 1536 may extend above vertical riser 475 and bypass weir 150 to further prevent trash from entering vertical riser 475 or exiting the system over bypass weir 150.

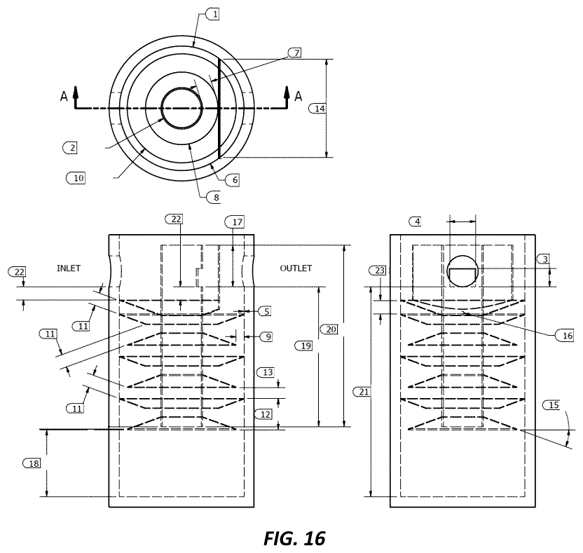

FIG. 16 depicts a plurality of dimensional designations that correspond with Table 1, presented below. Table 1 provides dimensions for six sizes of separators, such as separator 100. For example, separator 100 may be provided in six sizes-a three-foot, four-foot, five-foot, six-foot, eight-foot, or ten-foot diameter. Table 1 provides the dimensions of the various components of separator 100, as disclosed herein, for each of these sizes.

TABLE 1

| FIG. 16 | | | | | | | | |
|---|---|---|---|---|---|---|---|---|
| Reference | | | | | | | | |
| No. | Description | Units | Separator 100 Size Designation | | | | | |
| | Separator 100 | ft | 3 | 4 | 5 | 6 | 8 | 10 |
| | Size | | | | | | | |
| | Designation | | | | | | | |
| 1 | Diameter of | in | 36 | 48 | 60 | 72 | 96 | 120 |
| | Tubular Body | | | | | | | |
| | 160 | | | | | | | |
| 2 | Inner Diameter | in | 10.8 | 14.4 | 18 | 21.6 | 28.8 | 36 |
| | of Vertical | | | | | | | |
| | Cylinder 115 | | | | | | | |
| | Cross-Sectional | in² | 92 | 163 | 254 | 366 | 651 | 1018 |
| | Area of Vertical | | | | | | | |
| | Cylinder 115 | | | | | | | |
| 3 | Height of Inlet | in | 6.6 | 7.0 | 8.8 | 10.5 | 14.0 | 14.0 |
| | Port 120 | | | | | | | |
| 4 | Width of Inlet | in | 6 | 10 | 12.5 | 15 | 20 | 31.25 |
| | Port 120 | | | | | | | |
| | Area of Inlet | in² | 39.4 | 70.0 | 109.4 | 157.5 | 280.0 | 437.5 |
| | Port 120 | | | | | | | |
| 5 | Distance | in | 1.0 | 1.38 | 1.7 | 2.0 | 2.6 | 3.3 |
| | between | | | | | | | |
| | Upward Baffles | | | | | | | |
| | 135A-135C and | | | | | | | |
| | Inner Wall of | | | | | | | |
| | Tubular Body | | | | | | | |
| | 160 | | | | | | | |
| 6 | Outer Diameter | in | 35.01 | 46.63 | 58.35 | 70.02 | 93.36 | 116.70 |
| | of Upward | | | | | | | |
| | Baffles 135A- | | | | | | | |
| | 135C | | | | | | | |
| 7 | Length of | in | 3.08 | 4.11 | 5.13 | 6.16 | 8.21 | 10.26 |
| | Opening 968 | | | | | | | |
| 8 | Inner Diameter | in | n/a | n/a | n/a | n/a | n/a | n/a |
| | of Upward | | | | | | | |
| | Baffles 135A- | | | | | | | |
| | 135C | | | | | | | |
| 9 | Distance | in | 2.25 | 3 | 3.75 | 4.5 | 6 | 7.5 |
| | between | | | | | | | |
| | Downward | | | | | | | |
| | Baffles 140A- | | | | | | | |
| | 140C and Inner | | | | | | | |
| | Wall of Tubular | | | | | | | |
| | Body 160 | | | | | | | |
| 10 | Outer Diameter | in | 31.5 | 42 | 52.5 | 63 | 84 | 105 |
| | of Downward | | | | | | | |
| | Baffles 140A- | | | | | | | |
| | 140C | | | | | | | |
| 11 | Space Between | in | 2.25 | 5 | 4.5 | 4 | 6.75 | 8.25 |
| | Alternating | | | | | | | |
| | Upward Baffles | | | | | | | |
| | 135A-135C and | | | | | | | |
| | Downward | | | | | | | |
| | Baffles 140A- | | | | | | | |
| | 140C | | | | | | | |
| 12 | Spacing | in | 7.58 | 11.76 | 13.07 | 13.74 | 20.17 | 25.54 |
| | Between Upper | | | | | | | |
| | Edge of Upward | | | | | | | |
| | Baffle 135C and | | | | | | | |
| | Lower Edge of | | | | | | | |
| | Downward | | | | | | | |
| | Baffle 140C | | | | | | | |
| | (exemplary of | | | | | | | |
| | each of upward | | | | | | | |
| | baffles 135A- | | | | | | | |
| | 135C and | | | | | | | |
| | downward | | | | | | | |
| | baffles 140A- | | | | | | | |
| | 140C) | | | | | | | |
| 13 | Spacing | in | 1.58 | 5.1 | 3.42 | 2.6 | 5.45 | 6.04 |
| | Between Upper | | | | | | | |
| | Edge of Upward | | | | | | | |
| | Baffle 135C and | | | | | | | |
| | Lower Edge of | | | | | | | |
| | Downward | | | | | | | |
| | Baffle 140B | | | | | | | |
| | (exemplary of | | | | | | | |
| | each of upward | | | | | | | |
| | baffles 135A- | | | | | | | |
| | 135C and | | | | | | | |
| | downward | | | | | | | |
| | baffles 140A- | | | | | | | |
| | 140C) | | | | | | | |
| | Area of | in² | 132.6 | 260 | 349 | 534 | 922 | 1625 |
| | Opening 968 | | | | | | | |
| 14 | Length of | in | 29 | 38 | 50 | 58 | 78 | 92 |
| | Bypass Weir | | | | | | | |
| | 150 | | | | | | | |
| 15 | Surface Area of | deg. | 20 | 20 | 20 | 20 | 20 | 20 |
| | Downward | | | | | | | |
| | Baffles 140A- | | | | | | | |
| | 140C | | | | | | | |
| 16 | Number of | ea | 1 | 1 | 2 | 3 | 4 | 7 |
| | Drain Ports 163 | | | | | | | |
| 17 | Height of | in | 16 | 16 | 16 | 16 | 16 | 16 |
| | Bypass Weir | | | | | | | |
| | 150 | | | | | | | |
| 18 | Distance from | in | 22.3 | 24.7 | 24.0 | 23.8 | 44.4 | 56.1 |
| | Downward | | | | | | | |
| | Baffle 140C to | | | | | | | |
| | Base 145 | | | | | | | |
| 19 | Distance | in | 32.7 | 59.5 | 57.1 | 57.2 | 87.6 | 105.9 |
| | between Inlet | | | | | | | |
| | Port 120 and | | | | | | | |
| | Downward | | | | | | | |
| | Baffle 140C | | | | | | | |
| 20 | Height from | in | 48.7 | 76.0 | 73.1 | 73.1 | 107.0 | 121.9 |
| | Top of Vertical | | | | | | | |
| | Riser 475 to | | | | | | | |
| | Downward | | | | | | | |
| | Baffle 140C | | | | | | | |
| 21 | Distance from | in | 55 | 81 | 81 | 81 | 132 | 162 |
| | Inlet Port 120 to | | | | | | | |
| | Base 145 | | | | | | | |
| 22 | Distance from | in | 4.5 | 5.6 | 6 | 6.5 | 8 | 9 |
| | Inlet Port 120 to | | | | | | | |
| | Upper Cone 125 | | | | | | | |
| 23 | Distance | in | 2.8 | 5.32 | 4.79 | 4.25 | 7.72 | 8.85 |
| | between Upper | | | | | | | |
| | Cone 125 and | | | | | | | |
| | Upward Baffle | | | | | | | |
| | 135A | | | | | | | |
| | Angle to | degree | 65 | 60 | 65 | 60 | 60 | 60 |
| | support | | | | | | | |
| | Brackets | | | | | | | |

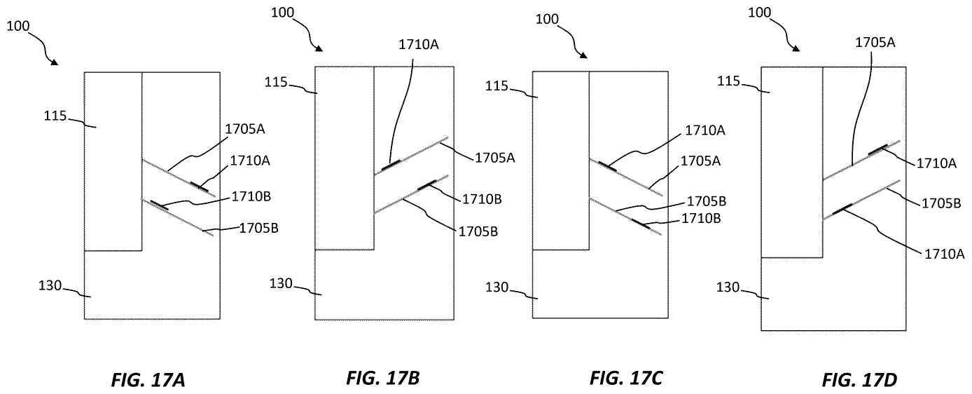

FIGS. 17A-17D depict an enlarged section cut of separator 100 with baffles 1705A-1705B. As depicted in FIGS. 17A-17D, baffles 1705A-1705B may be attached to vertical cylinder 115 in sump chamber 130 of separator 100. Baffles 1705A-1705B may each comprise a cone extending fully around vertical cylinder 115. Baffles 1705A-1705B may be configured to control a flow of stormwater within sump chamber 130 to allow sediments and particulates to settle from the flow of stormwater before exiting sump chamber 130. As depicted in each of FIGS. 17A-17D, baffles 1705A-1705B may extend in parallel at an upward angle or a downward angle towards an inner wall of separator 100. While baffles 1705A-1705B do not extend all the way to the inner wall of separator 100 in the embodiments depicted in FIGS. 17A-17D, in other embodiments (not shown), one or more of baffles 1705A-1705B may extend all the way to and may contact the inner wall of separator 100. As depicted in each of FIGS. 17A-17D, each of baffles 1705A-1705B may include a window 1710A-1710B. Window 1710A-1710B may comprise an opening in baffles 1705A-1705B, which may allow a flow of treated stormwater to flow through baffles 1705A-1705B upwardly towards an outlet (not depicted) of separator 100. As depicted in FIGS. 17B and 17C, window 1710A may be located closer to vertical cylinder 115 along baffle 1705A and window 1710B may be located closer to an inner wall of separator 100 along baffle 1705B. In some embodiments, window 1710A may extend all the way to vertical cylinder 115 and/or window 1710B may extend all the way to the inner wall of separator 100. As depicted in FIGS. 17A and 17D, window 1710A may be located closer to an inner wall of separator 100 along baffle 1705A and window 1710B may be located closer to vertical cylinder 115 along baffle 1710B. In some embodiments, window 1710A may extend all the way to the inner wall of separator 100 and/or window 1710B may extend all the way to vertical cylinder 115. Although FIGS. 17A-17D depict two baffles 1705A-1705B, separator 100 may include any number of baffles within sump chamber 130. Further, each of baffles 1705A-1705B may include more than one window along the length of baffle 1705A-1705B. In some embodiments, the size and shape of windows 1710A and 1710B may be the same and in other embodiments, the size and shape of windows 1710A and 1710B may vary. For example, in some embodiments, the size of window 1710A may be smaller than the size of window 1710B. In such an embodiment, the decreasing size of window 1710A compared to window 1710B may further facilitate the settlement of particulates and sediment out of the flow of stormwater.

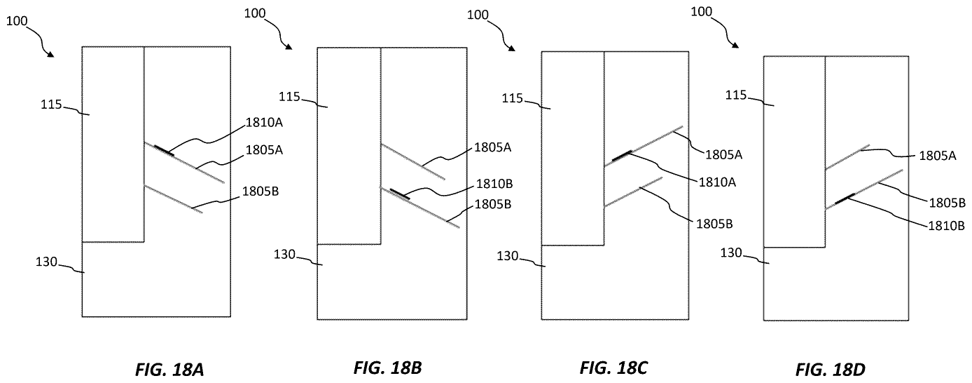

FIGS. 18A-18D depict an enlarged section cut of separator 100 with parallel baffles of varying widths. As depicted in FIGS. 18A-18D, baffles 1805A-1805B may be attached to vertical cylinder 115 in sump chamber 130 of separator 100. Baffles 1805A-1805B may each comprise a cone extending fully around vertical cylinder 115. Baffles 1805A-1805B may be configured to control a flow of stormwater within sump chamber 130 to allow sediments and particulates to settle from the flow of stormwater before exiting sump chamber 130. As depicted in each of FIGS. 18A-18D, baffles 1805A-1805B may extend in parallel at an upward angle or a downward angle towards an inner wall of separator 100. As depicted in FIGS. 5A and 5C, the width of baffle 1805B may be less than the width of baffle 1805A. In such embodiments, a flow of stormwater may pass through the gap between baffle 1805B and the inner wall of separator 100. Further, in such embodiments, baffle 1805A may include a window 1810A. Window 1810A may comprise an opening in baffle 1805A, which may allow a flow of treated stormwater to pass through baffle 1805A upwardly towards an outlet (not depicted) of separator 100. In some embodiments, window 1810A may extend all the way to the inner wall of separator 100 or all the way to vertical cylinder 115. While baffles 1805A-1805B do not extend all the way to the inner wall of separator 100 in the embodiments depicted in FIGS. 18A-18D, in other embodiments (not shown), baffles 1805A-1805B, if comprising one or more windows 1810A, 1810B, respectively, may extend all the way to and may contact the inner wall of separator 100. As depicted in FIGS. 5B and 5D, the width of baffle 1805A may be less than the width of baffle 1805B. In such embodiments, a flow of stormwater may pass through the gap between baffle 1805A and an inner wall of separator 100. Further, in such embodiments, baffle 1805B may comprise window 1810B. Window 1810B may comprise an opening in baffle 1805B, which may allow a flow of treated stormwater to pass through baffle 1805B upwardly towards an outlet (not depicted) of separator 100. In some embodiments, window 1810B may extend all the way to the inner wall of separator 100 or all the way to vertical cylinder 115. Although FIGS. 18A-18D depict two baffles 1805A-1805B, separator 100 may include any number of baffles of varying widths within sump chamber 130. In some embodiments, the size and shape of windows 1810A and 1810B may be the same and in other embodiments, the size and shape of windows 1810A and 1810B may vary.

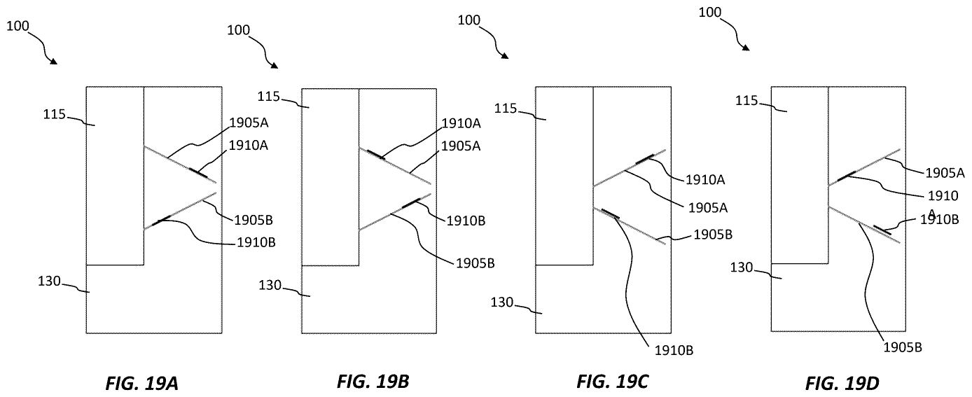

FIGS. 19A-19D depict an enlarged section cut of separator 100 with non-parallel baffles. As depicted in FIGS. 19A-19D, baffles 1905A-1905B may be attached to vertical cylinder 115 in sump chamber 130 of separator 100. Baffles 1905A-1905B may each comprise a cone extending fully around vertical cylinder 115. Baffles 1905A-1905B may be configured to control a flow of stormwater within sump chamber 130 to allow sediments and particulates to settle from the flow of stormwater before exiting sump chamber 130. As depicted in each of FIGS. 19A-19D, baffles 1905A-1905B may extend in non-parallel directions at an upward angle or a downward angle towards an inner wall of separator 100. For example, baffle 1905A may extend at an upward angle while baffle 1905B may extend at a downward angle, or vice versa. Each of baffles 1905A-1905B may include a window 1910A-1910B. Window 1910A-1910B may comprise an opening in baffles 1905A-1905B, which may allow a flow of treated stormwater to flow through baffles 1905A-1905B upwardly towards an outlet (not depicted) of separator 100. While baffles 1905A-1905B do not extend all the way to the inner wall of separator 100 in the embodiments depicted in FIGS. 19A-19D, in other embodiments (not shown), one or more of baffles 1905A-1905B may extend all the way to and may contact the inner wall of separator 100. As depicted in FIGS. 19B and 19D, window 1910A may be located closer to vertical cylinder 115 along baffle 1905A and window 1910B may be located closer to an inner wall of separator 100 along baffle 1905B. In some embodiments, window 1910A may extend all the way to the vertical cylinder 115 and/or window 1910B may extend all the way to the inner wall of separator 100. As depicted in FIGS. 19A and 19C, window 1910A may be located closer to an inner wall of separator 100 along baffle 1905A and window 1910B may be located closer to vertical cylinder 115 along baffle 1910B. In some embodiments, window 1910A may extend all the way to the inner wall of separator 100 and/or window 1910B may extend all the way to vertical cylinder 115. Although FIGS. 19A-19D depict two baffles 1905A-1905B, separator 100 may include any number of baffles within sump chamber 130. Additionally, each of baffles 1905A-1905B may include more than one window along the length of baffle 1905A-1905B. In some embodiments, the size and shape of windows 1910A and 1910B may be the same and in other embodiments, the size and shape of windows 1910A and 1910B may vary.

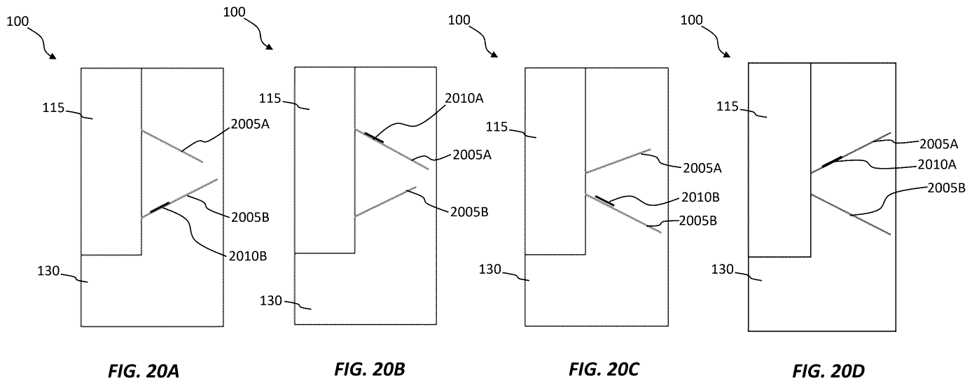

FIGS. 20A-20D depict an enlarged section cut of separator 100 with a plurality of non-parallel baffles of varying widths. As depicted in FIGS. 20A-20D, baffles 2005A-2005B may be attached to vertical cylinder 115 in sump chamber 130 of separator 100. Baffles 2005A-2005B may each comprise a cone extending fully around vertical cylinder 115. Baffles 2005A-2005B may be configured to control a flow of stormwater within sump chamber 130 to allow sediments and particulates to settle from the flow of stormwater before exiting sump chamber 130. As depicted in each of FIGS. 20A-20D, baffles 2005A-2005B may extend in non-parallel directions at an upward angle or a downward angle towards an inner wall of separator 100. As depicted in FIG. 20B, the width of baffle 2005B may be less than the width of baffle 2005A. In such embodiments, a flow of stormwater may pass through the gap between baffle 2005B and the inner wall of separator 100. Further, in such embodiments, baffle 2005A may include a window 2010A. Window 2010A may comprise an opening in baffle 2005A, which may allow a flow of treated stormwater to pass through baffle 2005A upwardly towards an outlet (not depicted) of separator 100. In some embodiments, window 2010A may extend all the way to the inner wall of separator 100 or all the way to vertical cylinder 115. While baffles 2005A-2005B do not extend all the way to the inner wall of separator 100 in the embodiments depicted in FIGS. 20A-20D, in other embodiments (not shown), baffles 2005A-2005B, if comprising one or more windows 2010A, 2010B, respectively, may extend all the way to and may contact the inner wall of separator 100. As depicted in FIGS. 20A and 20C, the width of baffle 2005A may be less than the width of baffle 2005B. In such embodiments, a flow of stormwater may pass through the gap between baffle 2005A and an inner wall of separator 100. Further, in such embodiments, baffle 2005B may comprise window 2010B. Window 2010B may comprise an opening in baffle 2005B, which may allow a flow of treated stormwater to pass through baffle 2005B upwardly towards an outlet (not depicted) of separator 100. In some embodiments, window 2010B may extend all the way to the inner wall of separator 100 or all the way to vertical cylinder 115. Although FIGS. 20A-20D depict two baffles 2005A-2005B, separator 100 may include any number of baffles of varying widths within sump chamber 130. In some embodiments, the size and shape of windows 2010A and 2010B may be the same and in other embodiments, the size and shape of windows 2010A and 2010B may vary.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations and/or alterations based on the present disclosure. Other embodiments will be apparent from consideration of the specification and practice of the embodiments disclosed herein.

What is claimed is:

1. A separator configured to remove particulate matter and pollutants from a flow of water, the separator comprising:
a tubular body, the tubular body comprising an inlet chamber and a sump chamber separated by an upper cone;
the inlet chamber comprising:
a vertical riser comprising an inlet port configured to direct the flow of water from the inlet chamber to the sump chamber;
the sump chamber comprising:
a plurality of upward baffles, wherein each of the plurality of upward baffles extend outwardly from a vertical cylinder section;
a plurality of downward baffles, wherein each of the plurality of downward baffles extend outwardly from the vertical cylinder section; and
wherein the plurality of upward baffles and the plurality of downward baffles are connected vertically in an alternating pattern to form a vertical cylinder configured to connect to the vertical riser.

2. The separator of claim 1, wherein the tubular body further comprises an inlet configured to receive the flow of water from a source.

3. The separator of claim 1, wherein the tubular body further comprises an outlet configured to remove the flow of water from the separator.

4. The separator of claim 3, wherein the inlet chamber further comprises a bypass weir configured to prevent the flow of water from entering the outlet from the inlet chamber.

5. The separator of claim 1, wherein each of the plurality of upward baffles comprises:
a first end having a first diameter; and
a second end having a second diameter;
wherein the first diameter is larger than the second diameter.

6. The separator of claim 5, wherein the second end of each of the plurality of upward baffles is located below the first end.

7. The separator of claim 6, wherein the first diameter corresponds to an inner diameter of the tubular body.

8. The separator of claim 7, wherein each of the plurality of upward baffles comprises a plurality of openings.

9. The separator of claim 1, wherein each of the plurality of downward baffles comprises:
a first end having a first diameter; and
a second end having a second diameter;
wherein the first diameter is larger than the second diameter.

10. The separator of claim 9, wherein the second end of the plurality of downward baffles is located above the first end.

11. The separator of claim 10, further comprising a gap between the first end of each of the plurality of downward baffles and an inner wall of the tubular body.

12. The separator of claim 1, wherein the vertical cylinder is configured to direct the flow of water from the inlet chamber to a lower portion of the sump chamber.

13. The separator of claim 1, wherein the vertical cylinder sections comprise alignment castellations configured to align adjacent vertical riser sections.

14. The separator of claim 13, wherein the alignment castellations comprise a plurality of grooves and a plurality of protrusions.

15. The separator of claim 13, wherein the alignment castellations comprise a plurality of tabs and a plurality of slots.

16. The separator of claim 13, wherein the alignment castellations of a first vertical riser section are configured to interlock with the alignment castellations of a second vertical riser section.

17. The separator of claim 1, wherein each of the plurality of upward baffles and each of the plurality of downward baffles comprises a marking.

18. The separator of claim 4, wherein the bypass weir comprises at least one weir tab configured to secure the bypass weir to an inner wall of the tubular body.

19. The separator of claim 4, wherein the vertical riser comprises a brace configured to secure the bypass weir.

20. The separator of claim 1, wherein the plurality of upward baffles comprises three upward baffles and the plurality of downward baffles comprises three downward baffles.
